(19) United States
(12) Patent Application Publication
(10) Pub. No.: US 2025/0259032 A1
(43) Pub. Date: Aug. 14, 2025

(54) FEDERATED DISTRIBUTED GRAPH-BASED COMPUTING PLATFORM

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/008,636

(22) Filed: Jan. 3, 2025

Related U.S. Application Data
(63) Continuation-in-part of application No. 18/656,612, filed on May 7, 2024.
(60) Provisional application No. 63/551,328, filed on Feb. 8, 2024.

(51) Int. Cl. G06N 3/042

(52) U.S. Cl. CPC G06N 3/042

(57) ABSTRACT

A federated distributed AI reasoning and action platform utilizing decentralized, partially observable hierarchical computing for neuro-symbolic reasoning. It features a federated Distributed Computational Graph (DCG) system integrating core components like pipeline orchestration, transformers, and marketplaces. The platform enables privacy-preserving dynamic resource allocation, intelligent task scheduling, and variable information sharing across diverse computing environments. By coordinating with an AI-based operating system and analyzing performance metrics, environmental conditions, and resource availability, the system optimizes efficiency across AI workloads and decision-making processes. This results in an adaptive, power-efficient, and scalable AI-enabled data processing system capable of handling complex tasks while maintaining peak performance under various operating conditions.

### CROSS-REFERENCE TO RELATED APPLICATIONS

Priority is claimed in the application data sheet to the following patents or patent applications, each of which is expressly incorporated herein by reference in its entirety:
Ser. No. 18/656,612
63/551,328

### BACKGROUND OF THE INVENTION

### Field of the Art

The present invention is in the field of federated large-scale cloud and edge computing, and more particularly on federated distributed graph-based computing platforms designed to enhance artificial intelligence based decision-making and automation systems with optional human-machine teaming including those employing approaches including large language models (LLMs) and associated services across heterogeneous environments, including cloud infrastructures, managed data centers, edge computing nodes, and wearable/mobile devices and diverse counterparties.

### Discussion of the State of the Art

The recent rapid rise in the capabilities and uses of machine learning, artificial intelligence (AI) and more recently large language models (LLMs) in support of generative artificial intelligence (GenAI or GAI) applications has raised myriad new challenges. New issues such as source data and model provenance, model hallucination and the protection of new threats to intellectual property rights, particularly copyrights and trademarks, against unattributed and unauthorized exploitation by AI models including LLMs, have arisen, while well-known challenges such as user privacy and cybersecurity have become even more difficult to effectively manage and easily understand. Dramatic new opportunities have also arisen as myriad participants rush to adopt more diverse data sources and feed growing machine learning, artificial intelligence and in particular GenAI and LLMs into their existing businesses and even to create entirely new business categories. This is leading to a proliferation of different micro-applications being integrated into computational processes and flows across a wide range of computing applications and modalities.

The most recent AI interest boom has been largely focused on the Transformer and Diffusion models that followed the “Attention is All You Need” paper. Transformer models, particularly in the context of language generation tasks, generate output one token (or “piece”) at a time. Each newly generated token is indeed used as part of the input for generating the next token. This process continues iteratively until the desired output length is achieved or an end-of-sequence token is generated. The popular ChatGPT, Gemini, Bard, LLaMa, and Claude are mainstay examples of models that rely on this core approach, including some variants that reflect on results or engage in basic model blending, consensus or quality control. Closely related are the Diffusion models, which are used primarily to generate new images by beginning with random noise and improving the quality across the entire image until prompts and imagery generate sufficient similarity; DALL-E, Midjourney, and Stable Diffusion are examples of this type of model. Other specific model types such as Mamba (including Vision Mamba), Kolmogrov Arnold, and other variants also essentially follow the same basic principles and utilization considerations.

It is important to note that foundational Large Language Models, like GPT-3 and GPT-4 and its follow on or competitive variants, are considered to be connectionist AI models rather than symbolic AI. They each have a Connectionist architecture: the currently in vogue LLMs are a special case of neural network architectures, specifically deep neural networks with millions to billions of parameters. These networks consist of interconnected nodes (neurons) organized in layers. The connections between neurons are weighted, and information flows through these connections during computation. These layers include an input layer, one or more hidden layers, and an output layer. This connectionist architecture is fundamentally different from the symbolic AI approach, which relies on explicit representations of symbols and rules. Further, they typically have a Distributed Representation: LLMs represent information in a distributed manner. Each neuron in the network contributes to the representation of multiple features or concepts simultaneously. In contrast, symbolic AI systems represent knowledge using discrete symbols (e.g. for objects, properties, and relationships) and rules for manipulating these symbols to enable reasoning and problem-solving. LLMs, by distributing information across a vast number of neurons and weights, can capture complex and nuanced patterns in data. These models all use Learning from Data: LLMs are trained through a data-driven approach, where they learn patterns and relationships from massive amounts of data. Large language models like GPT (Generative Pre-trained Transformer) are typically trained on vast amounts of text data. However, there are now emerging advanced models that are being designed to work with different types of data including images, video, audio, tabular/structured, multimodal, code, DNA, proteins, molecules, and computational fluid dynamics often building on top of foundational models trained on large text-dominant corpora and being further enhanced for specific applications with domain-specific tuning, such as Retrieval-Augmented Generation RAG enhancements or knowledge graph enhancements to meet practical performance needs. The base connectionist models do not rely on predefined symbolic representations (e.g. knowledge graphs) or explicit rules. Instead, they adjust their internal connections (weights) through training to improve their ability to predict the next element in a sequence, such as a word in a sentence, or generate coherent content. While most of the approaches noted thus far are effectively variations of Multi-Layer Perceptrons (MLPs) with fixed activation functions on nodes (“neurons”), we also note that Kolmogorov-Arnold Networks (KANs) have emerged as a promising alternative. KANs have learnable activation functions on edges (“weights”) that leverage a univariate function parameterized as a spline.

Symbolic AI, on the other hand, historically required explicit encoding of knowledge and rules and in earlier eras this relied heavily on manually curated expert knowledge. Further, Connectionist models like LLMs are known for their ability to generalize from the data they have seen during training to generate novel and contextually relevant responses or attempts. They can handle a wide range of tasks and domains by leveraging learned representations that often provide surprisingly convincing or plausible results. Symbolic artificial intelligence (AI) systems often historically struggle with generalization, as they typically require explicit rules for each specific task or domain and may not operate well when observed conditions are not closely correlated to their expected operating conditions. Connectionist models like LLMs lack explicit symbolic reasoning capabilities; that is, they do not have explicit symbols, symbolic representations or rules encoded within them and do not fundamentally understand concepts—they are effectively limited to patterns but can attempt to apply those patterns to any scenario regardless of how tenuous applicability may be. They generate responses based on patterns and associations learned from data utilized in training processes, but in doing so are largely “black box” systems. In contrast, older symbolic AI systems rely heavily on symbolic representations and rules that were once manually created and maintained and can be explained and traced as a result.

Overall, the connectionist nature of many current techniques like LLMs allows them to excel in various natural language understanding tasks and handle complex, context-rich data, making them a powerful tool for many potential AI applications such as content generation, chatbots, language translation, sentiment analysis, text summarization, classification and labeling, question answering and support applications, personalized or contextual recommendations, and comparative analysis. Symbolic AI, on the other hand, is traditionally viewed as being reliant on predefined symbols and rules. This requires formal treatment of data for analysis to enable association between the ontology associated with a given Symbolic application and a data set of interest. This need for highly congruent input and narrow domain framing and brittleness, which can be rigid and less adaptive in the face of real-world data variability, heterogeneity, and uncertainty, can limit its practical applications in many ways. But this common framing of Connectionist versus Symbolic fails to account for broader “systems” level views of practical AI applications which are ultimately of interest to prospective human or robotic agents, owners, and supervisors—who ultimately wish to accomplish something better, cheaper, and/or faster than would otherwise be possible with traditional data analytics, machine learning, or AI systems of either symbolic or connectionist origin.

Within the LLM space, using transformer-based models, word embedding is a technique that assigns words to numerical vectors in a way that connects similar words with vectors that are close in proximity and separates dissimilar words with distant vectors. These embeddings can then be compared and operated on with methods such as cosine similarity which yields a high number if two inputs are similar, and a small number if they are different. However, word embeddings have a significant limitation when dealing with words that have multiple meanings. For instance, if a word embedding assigns a vector to the word ‘bear,’ it assigns the same vector to all of its various definitions. This poses a challenge when you want to use the word ‘bear’ in different contexts. This is where the concept of attention comes into play. Paragraph level, document level, or “chunked” segment or term embedding faces many of the same challenges, just with different sampling issues or biases from the source material of interest.

Attention is a mechanism for distinguishing between words when they are used in diverse contexts, transforming word embeddings into contextualized word embeddings. The computer considers all the words in a sentence as context, even including seemingly irrelevant words like “the,” “of,” and “in.” However, it weighs them based on their similarity to the word ‘bear.’ In a well-designed embedding, the similarity between ‘bear’ and words like ‘the’ is nearly zero, indicating their lack of contextual relevance. Consequently, the model learns to ignore these insignificant words and focuses on those with higher similarity to ‘bear.’ Multi-head attention is a method that allows one to modify embeddings to create various attention mechanisms. These modifications can be trained, much as a neural network is trained to more precisely employ weightings reflecting multiple potential contexts—“Bear at the Zoo” is different from “Bear!” during a hiking trip is different from “bear with me” (i.e. be patient with me).

One of the overarching limitations about non-symbolic or Connectionist AI systems like LLMs is that they hallucinate, which can lead to dubious or truly false results. In some cases, LLMs have been known to make up and state facts that are untrue and were never part of their training data. As real-world consequences of making decisions or taking actions based on LLM outputs begin to appear—with concomitant safety and legal risks—connecting the output from a given LLM prompt to a knowledge base imbued with actual semantic meaning is needed. While many LLM companies like OpenAI and Anthropic and Cohere market things like Search Ranking or Semantic Search improvements using LLM overlays on traditional database queries (either user-constructed or constructed as an initial prompt output itself), the results, rankings etc. are not in fact imbued with any “semantic” knowledge or real understanding in the Symbolic sense. Such claims of semantic search are predicated on these kinds of similarity measures which indicate closeness based on contextual indicators derived from the training data—this is distinct from knowledge, comprehension, application, analysis, synthesis, and evaluation in the way used in Bloom's 1956 taxonomy or the 2001 revision which used Remember, Understand, Apply, Analyze, Evaluate, and Create. The effectiveness of meaning representation models or embeddings relies on distance measurement based on a corpora of training data from which vector similarity is determined. Several of the most popular vector similarity functions are Euclidean distance, cosine similarity, and the inner product. The most common linguistic structures in today's natural language tools remain a bag of words (no structure), sequential, constituent, and dependency parsing.

While Connectionist outputs are “made up” they are often nevertheless very compelling artifices which generate believable output that is sometimes correct. Believability may, but does not necessarily, equate to correctness, usefulness, or more broadly fitness for purpose (or optimization) given practical, legal, ethical, moral, and economic considerations and constraints that render a system or its output fit for purpose. This is further complicated by the need to update or evolve data sets and models, computational processes, and the systems of which they are a part, on an ongoing basis whether through continuous learning processes with retraining, reinforcement learning, or techniques like partially neural reinforcement learning which provide frameworks for ongoing verification of neural network based models within a learning loop inside of continuous state and action spaces.

The growth of increasingly available foundational models alongside specialized data, models, RAGs and tool chains is also driving much more focus on distributed graph-based flow programming of human and agentic workflows. While the core capabilities supporting current kinds of data and process flow programming as complete DCGs for analytical processes and for chaining of models to produce outputs (e.g., in even oriented multi-agent data processor applications like OpenAgents, LangChang, OpenAI Swarm, or Microsoft Magnetic One) have long been disclosed in U.S. patent application Ser. No. 15/931,534 through its pipeline orchestrator architecture providing orchestration of complex workflows, pipeline managers for runtime pipeline management, activity actors for discrete task handling, and service clusters with associated service actors for modular service execution and later enhanced for federated hierarchical cooperative computing (U.S. Pat. No. 10,514,954), security and privacy concerns or regulatory regimes (U.S. patent application Ser. No. 15/489,716), we note that more innovation is required for truly federated orchestration across counterparties where extensive lack of knowledge about aspects of the data/information being processed, the processing systems or networks or devices doing such work, or the counterparties involved is expected, persistent and perhaps even desirable. Highly federated execution of computationally enhanced workflows and transformations of digital and physical assets with deep and diverse and only sometimes declared (or perhaps known) supply chains or data processing support requires more advanced specification and interpretation capabilities with declarative domain-specific language support and the ability for flexible manual or programmatic construction and execution management paired with observability metrics, analytics and simulation modeling. Additionally, current distributed systems remain overly brittle and often struggle with specific challenges associated with distributed computing exemplified by the well-known fallacies of distributed computing: the network is reliable; latency is zero; bandwidth is infinite; the network is secure; topology doesn't change; there is one administrator; transport cost is zero; and the network is homogeneous. Current methodologies for resource pool management and leader election and distributed state machines necessary for coordinated resource pooling and execution remain insufficient for the highly varied, uncertain, dynamic, latency sensitive and increasingly mission critical workflows being injected into applications, chatbots and AI enhanced applications across diverse counterparties with extraordinarily complex digital and physical supply chains.

What is needed is a federated distributed graph-based computing platform for managing increasingly complex and heterogeneous machine learning, optimizing resource allocation across heterogeneous computing environments while maintaining privacy and security requirements despite numerous counterparties with distinct economic and other incentives (sometimes at odds), support for managing variable and uncertain trustworthiness and artificial intelligence enhanced data processing, that enables more flexible and contextual and declarative use of increasingly heterogeneous computing, transport, and storage technologies and balkanized technology, encryption, and privacy laws and regulations to support new business and technology opportunities to emerge at pace. Such a capability may also enable better responses to the new challenges raised by the dynamic new technology landscape faced by all after the rapid and haphazard introduction of myriad generative AI technologies and platforms, wearables and internet of things devices that are proliferating but require predictable and low-cost integration and collaborative engagement at scale with robust support for multiple interested parties and variable, uncertain, and often partial observability of computational and process flows.

### SUMMARY OF THE INVENTION

Accordingly, the inventor has conceived and reduced to practice, a federated distributed graph-based computing platform for heterogeneous computing environments with multiple organizational, human and AI agent participants. A multi-stakeholder distributed artificial intelligence (AI) reasoning and action and interaction platform that utilizes a cloud-based computing architecture for neuro-symbolic reasoning that can selectively and appropriately blend human action and insight, machine learning, artificial intelligence, statistics, and simulation modeling processes in support of continuous learning from both empirical observations and hypothetical state space explorations of decision spaces—with a particular applicability to decision making under uncertainty in complex adaptive systems but also with applicability for everyday interactions and delegated agentic activities. The platform comprises systems for federated distributed computation declaration, evaluation, distribution, execution and management along with curation, marketplace integration, and context management support human-machine teaming within complicated and complex cyber physical environments that have a wide range of business and decision-making applications over multiple scales, geographies, and timeframes. A federated distributed computational graph (DCG) orchestrates partially observable complex workflows for building and deploying algorithms and models, incorporating expert judgment, domain level expertise and understanding, and utilizing both internal and external data sources to improve a given system's, individual's, group's or organization's outcomes over time and across multiple devices and stakeholders or processes. This is facilitated in part by ongoing analysis of the system of interest to the observer, including with awareness of observer perspective, which is typically (but not necessarily) the beneficiary of the flow-based computing processes enabled by the system, and the evaluation of both experienced and hypothetical (e.g. via simulation or modeling) states over time under different perturbations or shocks from both internal or exogenous factors. A context computing system aggregates contextual data from local or global and internal or external sources or other localized DCG processes in the federated system made known to it (within a given system or as shared or made available from other systems such as via distribute state machine and associated gossip methods and consensus protocols), while a curation system provides curated responses from models (e.g. statistical, machine learning, simulation modeling based, or artificial intelligence including generative approaches like LLMs, deep learning models, or similar).

According to a preferred embodiment of the invention a core distinction of a federated DCG over previously DCGs now widely in use is that it is not necessary for any specific DCG in the federation to have knowledge and/or context of the entire federation of nodes or edges representing dataflows and tasks or processing steps for orchestration, and instead may only focus on the respective jobs and resources assigned for processing. DCGs within a federation may communicate context and state as much or as little as needed to accomplish the job objectives and to enable potential tiers or tessellations of resource pools to compete for processing and task roles and for pipeline definition, context and state updates. Marketplaces offer data (including unstructured, structured, schematized, normalized, and semantified for both real or synthetic), algorithms, models, model components, worlds or artifacts of them, and expert judgment(s) for purchase or integration or inspiration or training of downstream work or algorithms or new synthetic data sets. The platform enables enterprises to construct user-defined workflows and incorporate trained models into their business processes, leveraging enterprise-specific knowledge and for individuals to do effectively the same with temporally, spatially, and experience based tagging and aggregation of knowledge and experience and exposure over their life. The platform facilitates flexible and scalable integration of statistical, machine learning and artificial intelligence and simulation models into software applications, supported by a dynamic and adaptive federated DCG architecture that supports execution of data flows and orchestration of resources across cloud (e.g. hyperscale), self-managed (e.g. traditional data center) compute clusters, CDNs (e.g. forward content distribution networks that may expand from historical distribution of web content into forward hosting of data sets, models, AI tools, etc. . . . ), edge devices, wearables and mobile devices, and individual computers where computational graph specifications may also be communicated between different people, processes, AI agents and collections of logical or hardware resources. This federated DCG architecture not only supports pipeline definition of transformation tasks, especially via a Data Service Layer (DSL) for recipe and template like creation of flows, but enables the express establishment of dependencies and bill of materials from resources, data sets, algorithms, models, and rules/regulations applicable to the data flow being established. This may also optionally include the consideration of both first, 3rd, and 4th party compute, transport and storage dependencies with optional declaration of compute transport or storage locality for express, resource-dependent or economically dependent, or allowed locality instruction. The inventions' ability to orchestrate just-in-time, just-in-place, and just-in-context data flow processing across ecosystems, leveraging specific computing and networking constraints—both physical and logical, with multiple stakeholders who may have usage or licensing or economic considerations tied to highly distributed and heterogeneous data processing flows represents a substantial step forward above current cloud based orchestration of data flows and resources (including serverless kinds of architectures like Serverless Flink and schema registries) to provide a much more flexible, comprehensive and manageable means of enabling highly integrated multi-vendor/processor workflows for businesses, organizations, consumers, AI agents and automation engines, and programmers alike. This flexibility is in part enabled by distributed state and job objective management through DCG intercommunication through industry standard communication which may include but is not limited to gossip protocols or gossip-like consensus algorithms, communication protocols (e.g., the Zookeeper Atomic Broadcast (ZAB) protocol at the core of Zookeeper, the Raft consensus algorithm and associated communication model in Kraft, or other protocols or consensus algorithms like Paxos, or serverless implementations like FaasKeeper). This is critical for enabling more advanced kinds of federated and transfer learning at scale and better addressing privacy concerns, data locality regulations/restrictions, and user preferences on top of efficiency in processing, transport and storage of data at massive scale.

According to a preferred embodiment, a computing system for a federated distributed graph-based computing platform with an integrated hardware management layer, the computing system comprising: one or more hardware processors configured for: receiving a plurality of tasks from a first plurality of federated distributed graph-based systems; forwarding the plurality of tasks to a centralized distributed graph-based system; analyzing and decomposing tasks into a plurality of subtasks with varying levels of visibility and access requirements; generating a plurality of compute graphs that represent the plurality of subtasks; distributing the plurality of compute graphs to a second plurality of federated distributed graph-based systems which comprises a plurality of privacy and security settings; and executing the subtasks represented by the plurality of compute graphs, is disclosed.

According to a preferred embodiment, a computer-implemented method executed on a federated distributed graph-based computing platform, the computer-implemented method comprising: receiving a plurality of tasks from a first plurality of federated distributed graph-based systems; forwarding the plurality of tasks to a centralized distributed graph-based system; analyzing and decomposing tasks into a plurality of subtasks with varying levels of visibility and access requirements; generating a plurality of compute graphs that represent the plurality of subtasks; distributing the plurality of compute graphs to a second plurality of federated distributed graph-based systems which comprises a plurality of privacy and security settings; and executing the subtasks represented by the plurality of compute graphs, is disclosed.

According to a preferred embodiment, A system for a federated distributed graph-based computing platform with an integrated hardware management layer, comprising one or more computers with executable instructions that, when executed, cause the system to: receive a plurality of tasks from a first plurality of federated distributed graph-based systems; forward the plurality of tasks to a centralized distributed graph-based system; analyze and decomposing tasks into a plurality of subtasks with varying levels of visibility, execution flexibility and access requirements; generate a plurality of probabilistic compute graphs that represent the plurality of subtasks and relationships; distribute the plurality of compute graphs to a second plurality of federated distributed graph-based systems which comprises a plurality of resource states, privacy practices and security settings or postures; and execute the subtasks represented by the plurality of probabilistic compute graphs, is disclosed.

According to an aspect of an embodiment, the second plurality of federated distributed graph-based systems are assigned subtasks from the plurality of subtasks based on the second plurality of federated distributed graph-based systems' privacy and security settings.

According to an aspect of an embodiment, the plurality of compute graphs contain various amounts of information, such that some of the second plurality of federated distributed graph-based systems are provided with more information than others.

According to an aspect of an embodiment, the plurality of tasks, subtasks, and compute graphs are received, forwarded, analyzed, and distributed through a data pipeline network that connects the first plurality of federated graph-based systems, the centralized distributed graph-based system, and the second plurality of federated distributed graph-based systems.

According to an aspect of an embodiment, the federated distributed computational graph where computational graphs, in whole or in part, are encoded and communicated across devices alongside other data such as application data or models or data sets or weightings. In a preferred embodiment, federated DCG enables system-wide execution with decentralized and even blind or partially blind execution across tiers and tessellations of computing resources, rendering partially observable collaborative yet decentralized and distributed computing for complex processing and task flows possible with rule, score, weighting, market/bid, or optimization or planning based selection at local, regional or global level. The federation manager facilitates this through resource registry, task analyzer, and matching engine components, enabling dynamic orchestration while maintaining granular privacy and security controls. This architecture allows federated DCGs to communicate state and context information selectively through privacy and security module, with custom compute graphs containing varying levels of visibility tailored to each node's clearance and requirements. The system supports both centralized coordination through DCG and decentralized operation where federated DCGs maintain autonomous control over their resources and processing decisions while participating in the broader federation through secure communication interface.

According to an aspect of an embodiment, the federated DCG system implements a multi-level approach to resource coordination and task distribution through specialized components. The federation manager orchestrates distribution of workloads using resource registry to maintain dynamic inventory of available resources across federated nodes, task analyzer to decompose complex tasks into appropriately-sized subtasks, and matching engine to align tasks with suitable federated DCGs based on their capabilities, current workloads, and security clearances. Communication between federated units occurs through pipeline structures with pipeline managers overseeing different segments of workflow execution. Each federated DCG can interact with corresponding local service clusters and associated Service Actors to execute tasks while maintaining flexible connections to the broader federated network. This architecture enables efficient local processing while preserving the ability to selectively share information and resources across the federation according to established privacy specifications and security requirements. The system supports various operational patterns including peer-to-peer federation where DCGs discover and coordinate directly with each other, hierarchical arrangements where certain DCG's act as regional coordinators, and hybrid approaches that combine aspects of both centralized and decentralized operation.

### BRIEF DESCRIPTION OF THE DRAWING FIGURES

FIG. 1 is a block diagram illustrating an exemplary system architecture for a distributed generative artificial intelligence reasoning and action platform, according to an embodiment.

FIG. 2 is a block diagram illustrating an exemplary aspect of a distributed generative AI reasoning and action platform incorporating various additional contextual data.

FIG. 3 is a diagram illustrating incorporating symbolic reasoning in support of LLM-based generative AI, according to an aspect of a neuro-symbolic generative AI reasoning and action platform.

FIG. 4 is a block diagram illustrating an exemplary architecture for a neuro-symbolic generative AI reasoning and action platform configured for federated learning at a plurality of edge devices, according to an embodiment.

FIG. 5 is a block diagram illustrating an exemplary architecture for a neuro-symbolic generative AI reasoning and action platform configured to utilize a midserver to act as a computing intermediary between a plurality of edge devices and the platform.

FIG. 6 is a block diagram illustrating an exemplary mobile device configured for experience curation using embedded capabilities and functionality provided by a neuro-symbolic generative AI reasoning and action platform, according to an embodiment.

FIG. 7 is a block diagram illustrating an exemplary aspect of a distributed generative artificial intelligence reasoning and action platform, a curation computing system.

FIG. 8 is a block diagram illustrating an exemplary aspect of a distributed generative artificial intelligence reasoning and action platform, a marketplace computing system.

FIG. 9 is a block diagram illustrating a simple example of a distributed computational graph representation for providing neuro-symbolic GenAI capabilities, according to an aspect.

FIG. 10 is a block diagram illustrating an exemplary aspect of an embodiment of a distributed computational graph computing system utilizing an advanced cyber decision platform (ACDP) for external network reconnaissance and contextual data collection.

FIG. 11 is a block diagram illustrating another exemplary aspect of an embodiment of a distributed computational graph computing systems utilizing an advanced cyber decision platform.

FIG. 12 is a diagram of an exemplary architecture for a system for rapid predictive analysis of very large data sets using an actor-driven distributed computational graph, according to one aspect.

FIG. 13 is a diagram of an exemplary architecture for a system for rapid predictive analysis of very large data sets using an actor-driven distributed computational graph, according to one aspect.

FIG. 14 is a diagram of an exemplary architecture for a system for rapid predictive analysis of very large data sets using an actor-driven distributed computational graph, according to one aspect.

FIG. 15 is a block diagram of an architecture for a transformation pipeline within a system for predictive analysis of very large data sets using a distributed computational graph computing system.

FIG. 16 is a process flow diagram of a method for predictive analysis of very large data sets using the distributed computational graph

FIG. 17 is a process flow diagram of a method for an aspect of modeling the transformation pipeline module as a directed graph using graph theory.

FIG. 18 is a flow diagram illustrating an exemplary method for providing experience curation, according to an aspect of an embodiment.

FIG. 19 is a flow diagram illustrating an exemplary method for providing experience curation with using rich contextual data, according to an aspect of an embodiment.

FIG. 20 is a flow diagram illustrating an exemplary method for providing distributed neuro symbolic reasoning and action, according to an aspect of an embodiment.

FIG. 21 is a flow diagram illustrating an exemplary method for using a distributed computation graph system for creating structured representations or knowledge graphs from various data sources, and setting up a pipeline for continuous processing and monitoring of that data, according to an embodiment.

FIG. 22 is a block diagram illustrating an exemplary system architecture for a federated distributed graph-based computing platform.

FIG. 23 is a block diagram illustrating an exemplary system architecture for a federated distributed graph-based computing platform that includes a federation manager.

FIG. 24 is a block diagram illustrating an exemplary component of a federated distributed graph-based computing platform that includes a federation manager, the federation manager.

FIG. 25 is a block diagram illustrating an exemplary system architecture for a federated distributed graph-based computing platform that includes a federation manager where different compute graphs are forward to various federated distributed computation graph systems.

FIG. 26 is a flow diagram illustrating an exemplary method for a federated distributed graph-based computing platform.

FIG. 27 is a flow diagram illustrating an exemplary method for a federated distributed graph-based computing platform that includes a federation manager.

FIG. 28 illustrates an exemplary computing environment on which an embodiment described herein may be implemented.

FIG. 29 is a flow diagram illustrating an exemplary method for implementing gossip and consensus flows within and across tiers and tessellations of resource pools in a federated distribution graph-based computing platform.

### DETAILED DESCRIPTION OF THE INVENTION

A federated distributed graph-based computing platform with an integrated hardware management layer for managing and operationalizing artificial intelligence enhanced decision-making and automation systems including large language models and neuro-symbolic reasoning and automation systems. A distributed planning, machine learning, artificial intelligence, modeling simulation and generative artificial intelligence (AI) reasoning and action platform that utilizes a cloud-based computing architecture for operationalizing neuro-symbolic reasoning in real-world applications. The platform comprises systems for distributed computation, curation, marketplace integration, and context management across heterogeneous computing environments across heterogeneous cloud, managed data center, edge, and wearable/mobile devices where entire process graphs, data and models may be moved seamlessly between physical or logical devices for execution on a dynamic basis.

A federated distributed computational graph (DCG) creates, stores, analyzes, orchestrates, and refines complex workflows for building and deploying intelligent decision support, decision making, and automation systems for machine and human machine teamed processes leveraging, statistics, simulation modeling, machine learning, artificial intelligence, automated planning, and generative AI, incorporating expert judgment and internal and external data sources and marketplaces for data, models, algorithms, model weights, experts and third party APIs or services. A just-in-place, just-in-time, and just-in-context computing system aggregates data, while a curation system provides curated responses from selected trained models and resources. Marketplaces offer data, algorithms, databases, model weights and components, models and expert judgment for purchase or integration. The platform enables enterprises to construct user-defined workflows and incorporate trained models into their business processes, leveraging enterprise-specific knowledge. The platform facilitates flexible and scalable integration of machine learning models into software applications, supported by a dynamic and adaptive DCG architecture across heterogeneous resource pools with a declarative language domain-specific language for resource, transformation, and process flows across heterogeneous resource pools with awareness of legal, regulatory, privacy, economic, technology velocity (e.g. Avro or Spark or Flink or Kafka or Beam becoming more or less active).

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within a transformation pipeline are represented as a directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that a transformation graph may assume many shapes and sizes with a vast topography of edge relationships and node types. It is also important to note that the resource topologies available at a given execution time for a given pipeline may be highly dynamic due to changes in available node or edge types or topologies (e.g. different servers, data centers, devices, network links, etc.) being available, and this is even more so when legal, regulatory, privacy and security considerations are included in a DCG pipeline specification or recipe in the DSL. Since the system can have a range of parameters (e.g. authorized to do transformation x at compute locations of a, b, or c) the JIT, JIC, JIP elements can leverage system state information (about both the processing system and the observed system of interest) and planning or modeling modules to compute at least one parameter set (e.g. execution of pipeline may say based on current conditions use compute location b) at execution time. This may also be done at the highest level or delegated to lower level resources when considering the spectrum from centralized cloud clusters (i.e. higher) to extreme edge (e.g. a wearable, or phone or laptop). The examples given were chosen for illustrative purposes only and represent a small number of the simplest of possibilities. These examples should not be taken to define the possible graphs expected as part of operation of the invention

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “pipeline,” as used herein and interchangeably referred to as a “data pipeline” or a “processing pipeline,” refers to a set of data streaming activities and batch activities. Streaming and batch activities can be connected indiscriminately within a pipeline and compute, transport or storage (including temporary in-memory persistence such as Kafka topics) may be optionally inferred/suggested by the system or may be expressly defined in the pipeline domain specific language. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, a certain data size or chunk, or optionally an internal (e.g. APM or trace or resource based trigger) or external trigger (e.g. from another user, pipeline, or exogenous service). The events are held in a queue (e.g. Kafka) or similar until processing. Each batch activity may contain a “source” data context (this may be a streaming context if the upstream activities are streaming), and a “destination” data context (which is passed to the next activity). Streaming activities may sometimes have an optional “destination” streaming data context (optional meaning: caching/persistence of events vs. ephemeral). System also contains a database containing all data pipelines as templates, recipes, or as run at execution time to enable post-hoc reconstruction or re-evaluation with a modified topology of the resources (e.g. compute, transport or storage), transformations, or data involved.

### Conceptual Architecture

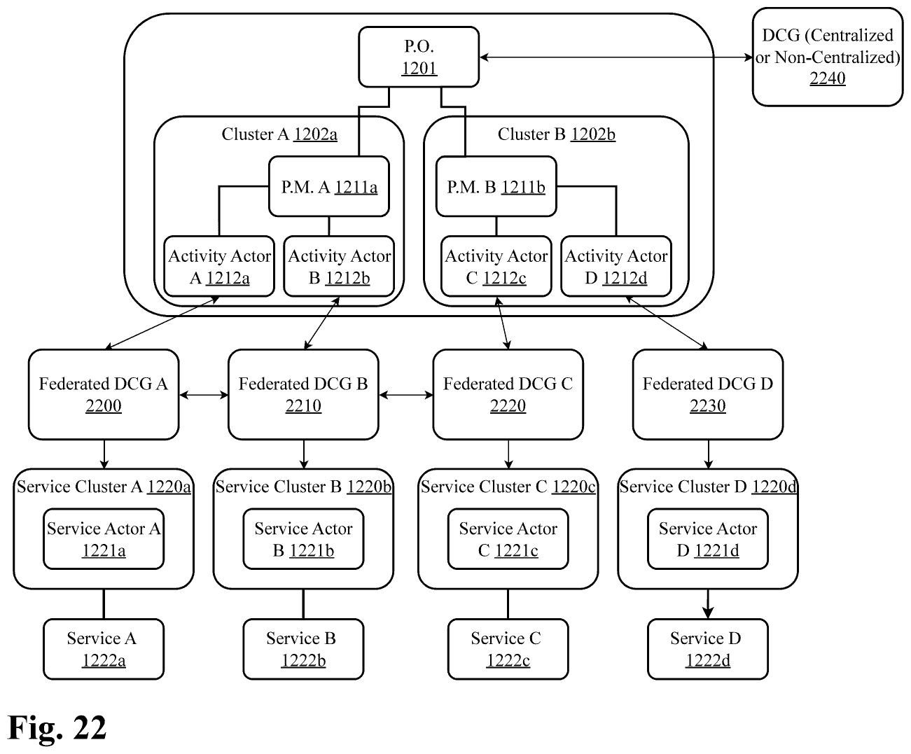

FIG. 22 is a block diagram illustrating an exemplary system architecture for a federated distributed graph-based computing platform. The system comprises a centralized DCG 2240 that coordinates with a plurality of federated DCGs 2200, 2210, 2220, and 2230, each representing a semi-independent computational entity.

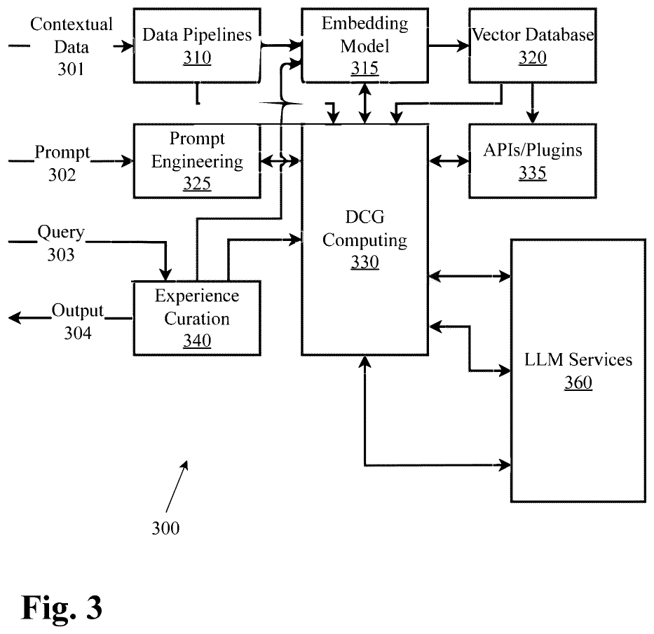

The interaction between federated units in this system represents one of several possible architectural patterns for coordinating distributed computing tasks. The federated architecture supports multiple implementation approaches, with centralized DCG 2240 representing just one possible configuration. In a peer-to-peer federation pattern, DCGs can operate in a fully decentralized manner, discovering and coordinating with each other through gossip protocols, where each DCG advertises its capabilities and available resources to peers, and workloads are distributed through direct DCG-to-DCG communication without central coordination. For bot-to-bot federation scenarios, each DCG can act as an interface to specific user requests or tasks, with DCGs discovering peer capabilities through gossip protocols and matching tasks to capabilities through autonomous selection. This coordination may be implemented through industry standard communication protocols including but not limited to gossip-like consensus algorithms, the Zookeeper Atomic Broadcast (ZAB) protocol, the Raft consensus algorithm and associated communication model in KRaft, or other protocols or consensus algorithms like Paxos, or serverless implementations like FaasKeeper. DCGs within a federation may communicate context and state as much or as little as needed to accomplish job objectives and to enable potential tiers or tessellations of resource pools to compete for processing and task roles and for pipeline definition, context and state updates. This approach supports execution of data flows and orchestration of resources across cloud (e.g., hyperscale), self-managed (e.g., traditional data center) compute clusters, CDNs, edge devices, wearables and mobile devices, and individual computers where computational graph specifications may also be communicated between different people, processes, AI agents and collections of logical or hardware resources. When implemented as a centralized federation, as shown with DCG 2240, it may maintain a high-level view of resources and processes similar to syndication patterns in enterprise architecture, though with limited visibility into internal DCG operations. For instance, in this pattern, task distribution may be facilitated by the centralized DCG 2240, but the fundamental capabilities for autonomous operation remain distributed across the federation, allowing each DCG to maintain independent control over its resources and processing decisions. In one embodiment, centralized DCG 2240 oversees the distribution of workloads across the federated system, maintaining a high-level view of available resources and ongoing processes. In some embodiments, centralized DCG 2240 may not have full visibility or control over the internal operations of each federated DCG. Each DCG system involved in the federated DCG platform may be represented by the system 300 as depicted in FIG. 3.

Each federated DCG (2200, 2210, 2220, 2230) operates as a semi-autonomous unit. These federated DCGs have their own internal structure, similar to the DCG depicted in FIG. 3. In one embodiment, each federated DCG communicates through pipelines that extend across multiple systems, facilitating a flexible and distributed workflow. The pipeline orchestrator P.O. 1201 serves as a conduit for task delegation from the DCG 2240 to the federated DCGs. Each federated DCG (2200, 2210, 2220, 2230) operates as a fully autonomous unit with complete capability to function independently within the federation. These federated DCGs have their own internal structure, similar to the DCG depicted in FIG. 3, and can operate without requiring central coordination. The federated DCGs communicate through pipelines that extend across multiple systems, enabling flexible and distributed workflows through various architectural patterns. In one implementation, DCGs can directly advertise and coordinate tasks with other DCGs in the federation without central mediation, where the pipeline orchestrator P.O. 1201 in each DCG manages task distribution and execution locally while coordinating with peer DCGs through federation protocols. These pipelines may span any number of federated systems, with a plurality of pipeline managers (P.M. A 1211a, P.M. B 1211b, etc.) overseeing different segments or aspects of the workflow based on whether the federation is operating in peer-to-peer, hierarchical, or hybrid patterns. Federated DCGs interact with corresponding local service clusters 1220a-d and associated Service Actors 1221a-d to execute tasks represented by services 1222a-d, allowing for efficient local processing while maintaining flexible connections to the broader federated network through whichever federation pattern best suits the current needs. While a centralized orchestration through DCG 2240 may be implemented in some scenarios, it represents just one possible configuration rather than a requirement of the federation architecture. These pipelines may span any number of federated systems, with a plurality of pipeline managers (P.M. A 1211a, P.M. B 1211b, etc.) overseeing different segments or aspects of the workflow. Federated DCGs interact with corresponding local service clusters 1220a-d and associated Service Actors 1221a-d to execute tasks represented by services 1222a-d, allowing for efficient local processing while maintaining a connection to the broader federated network.

Centralized DCG 2240 may delegate resources and projects to federated DCGs via the pipeline orchestrator P.O. 1201, which then distributes tasks along the pipeline structure. This hierarchical arrangement allows for dynamic resource allocation and task distribution across the federation. Pipelines can be extended or reconfigured to include any number of federated systems, adapting to the complexity and scale of the computational tasks at hand.

Federated DCGs 2200, 2210, 2220, and 2230 may take various forms, representing a diverse array of computing environments. They may exist as cloud-based instances, leveraging the scalability and resources of cloud computing platforms. Edge computing devices can also serve as federated DCGs, bringing computation closer to data sources and reducing latency for time-sensitive operations. Mobile devices, such as smartphones or tablets, can act as federated DCGs, contributing to the network's processing power and providing unique data inputs. Other forms may include on-premises servers, IoT devices, or even specialized hardware like GPUs or TPUs. This heterogeneity allows the federated DCG platform to adapt to various computational needs and take advantage of diverse computing resources, creating a robust and versatile distributed computing environment.

In this federated system, workloads can be distributed across different federated DCGs based on a plurality of factors such as but not limited to resource availability, data locality, privacy requirements, or specialized capabilities of each DCG. Centralized DCG 2240 may assign entire pipelines or portions of workflows to specific federated DCGs, which then manage the execution internally. Communication between centralized DCG 2240 and federated DCGs, as well as among federated DCGs themselves, may occur through the pipeline network which is being overseen by the plurality of pipeline managers and the pipeline orchestrator P.O. 1201.

The interaction between federated units, the centralized unit, and other federated units in this system may be partially governed by privacy specifications, security requirements, and the specific needs of each federated unit. The interaction between federated DCGs in this system is governed by self-enforced privacy specifications, security requirements, and the specific operational needs of each federated unit. Each DCG autonomously manages its privacy and security constraints while participating in the federation. For example, a DCG processing healthcare data can maintain internal mapping tables for data anonymization, transform sensitive data using temporary IDs before sharing, and control data visibility without requiring other DCGs to be aware of the underlying privacy measures. In one embodiment, DCGs advertise their operational requirements to the federation, such as geographic processing restrictions (e.g., EU-only data processing), security clearance requirements, and regulatory compliance certifications. When assigning or accepting tasks, each DCG independently evaluates and enforces its privacy and security controls based on its declared capabilities. For instance, a DCG might autonomously determine whether to process sensitive healthcare data based on its certifications and security measures, without requiring central coordination. While a centralized DCG 2240 may exist in some implementations to facilitate coordination, the fundamental privacy and security controls remain distributed across the federated DCGs, enabling flexible and secure collaboration through self-managed privacy controls and peer-based task distribution. DCG 2240 may manage the overall workflow distribution while respecting privacy and security constraints. In one embodiment, DCG 2240 may be centralized and maintain a high-level view of the system but may have limited insight into the internal operations of each federated DCG. When assigning tasks or pipelines, DCG 2240 may consider the privacy specifications associated with the data and the security clearance of each federated DCG. For instance, it might direct sensitive healthcare data only to federated DCGs with appropriate certifications or security measures in place.

Federated DCGs (2200, 2210, 2220, 2230) may interact with the DCG 2240 and each other based on predefined rules and current needs. A federated DCG might request additional resources or specific datasets from other DCGs 2240, which would then evaluate the request against security protocols before granting access. In cases where direct data sharing between federated DCGs is necessary, DCG 2240 may facilitate this exchange, acting as an intermediary to ensure compliance with privacy regulations. The level of information sharing between federated DCGs can vary. Some units might operate in isolation due to strict privacy requirements, communicating only with DCG 2240. Others might form collaborative clusters, sharing partial results or resources as needed. For example, federated DCG 2200 might share aggregated, anonymized results with federated DCG 2210 for a joint analysis, while keeping raw data confidential.

DCG 2240 may implement a granular access control system, restricting information flow to specific federated DCGs based on the nature of the data and the task at hand. It may employ techniques like differential privacy or secure multi-party computation to enable collaborative computations without exposing sensitive information. In scenarios requiring higher security, DCG 2240 may create temporary, isolated environments where select federated DCGs can work on sensitive tasks without risking data leakage to the broader system. This federated approach allows for a balance between collaboration and privacy, enabling complex, distributed computations while maintaining strict control over sensitive information. The system's flexibility allows it to adapt to varying privacy and security requirements across different domains and use cases, making it suitable for a wide range of applications in heterogeneous computing environments.

In another embodiment, a federated DCG may enable an advanced data analytics platform to support non-experts in machine-aided decision-making and automation processes. Users of this system may bring custom datasets which need to be automatically ingested by the system, represented appropriately in nonvolatile storage, and made available for system-generated analytics to respond to with questions the user(s) want to have answered or decisions requiring recommendations or automation. In this case the DCG orchestration service would create representations of DCG processes that have nodes that each operate on the data to perform various structured extraction tasks, to include schematization, normalization and semantification activities, to develop an understanding of the data content via classification, embedding, chunking, and knowledge base construction and vector representation persistence and structured and unstructured data view generation and persistence, and may also smooth, normalize or reject data as required to meet specified user intent. Users may optionally be asked to provide feedback, e.g. via layperson content and subsequent interpretation by LLM re: the generated tasks or DCG pipelines generated, or in expert or power user modes access or view or modify actual declarative formulations of pipelines or transformation tasks. Based on the outcome of the individual transformation steps and various subgraph pipeline execution and analysis additional data may be added over time or can be accessed from either a centralized data repository, or enriched via ongoing collection from one or more live sources. Data made available to the system can then be tagged and decomposed or separated into multiple sets for training, testing, and validation via pipelines or individual transformation stages. A set of models must then be selected, trained, and evaluated before being presented to the user, which may optionally leverage data and algorithm marketplace functionality. This step of model selection, training, and evaluation can be run many times to identify the optimal combination of input dataset(s), selected fields, dimensionality reduction techniques, model hyper parameters, embeddings, chunking strategies, or blends between use of raw, structured, unstructured, vector and knowledge corpora representations of data for pipelines or individual transformation nodes. The ongoing search and optimization process engaged in by the system may also accept feedback from a user and take new criteria into account such as but not limited to changes in budget that might impact acceptable costs or changes in timeline that may render select techniques or processes infeasible. This may mean system must recommend or select a new group of models, adjusting how training data was selected, or how the model outputs are evaluated or otherwise adjust DCG pipelines or transformation node declarations according to modified objective functions which enable comparative ranking (e.g. via score, model or user feedback or combination) of candidate transformation pipelines with resource and data awareness. The user doesn't need to know the details of how models are selected and trained, but can evaluate the outputs for themselves and view ongoing resource consumption, associated costs and forward forecasts to better understand likely future system states and resource consumption profiles. Based on outputs and costs, they can ask additional questions of the data and have the system adjust pipelines, transformations or parameters (e.g. model fidelity, number of simulation runs, time stepping, etc. . . . ) as required in real time for all sorts of models including but not limited to numerical methods, discrete event simulation, machine learning models or generative AI algorithms

According to another embodiment, a federated DCG may enable advanced malware analysis by accepting one or more malware samples. Coordinated by the DCG, system may engage in running a suite of preliminary analysis tools designed to extract notable or useful features of any particular sample, then using this information to select datasets and pretrained models developed from previously observed samples. The DCG can have a node to select a new model or models to be used on the input sample(s), and using the selected context data and models may train this new model. The output of this new model can be evaluated and trigger adjustments to the input dataset or pretrained models, or it may adjust the hyperparameters of the new model being trained. The DCG may also employ a series of simulations where the malware sample is detonated safely and observed. The data collected may be used in the training of the same or a second new model to better understand attributes of the sample such as its behavior, execution path, targets (eg: what operating systems, services, networks is it designed to attack), obfuscation techniques, author signatures, or malware family group signatures.

According to an embodiment, a DCG may federate and otherwise interact with one or more other DCG orchestrated distributed computing systems to split model workloads and other tasks across multiple DCG instances according to predefined criteria such as resource utilization, data access restrictions and privacy, compute or transport or storage costs et cetera. It is not necessary for federated DCGs to each contain the entire context of workload and resources available across all federated instances and instead may communicate, through a gossip protocols or gossip-like consensus algorithms, communications protocols (e.g., the Zookeeper Atomic Broadcast (ZAB) protocol at the core of Zookeeper, the Raft consensus algorithm and associated communication model in KRaft, or other protocols or consensus algorithms like Paxos, or serverless implementations like FaasKeeper), to collectively assign resources and parts of the model workload across the entire federation. DCGs within a federation may communicate context and state as much or little as needed to accomplish job objectives and to enable potential tiers or tessellations of resource pools to compete for processing and task roles and for pipeline definition, context and state updates. In this way it is possible for a local private DCG instance to use resources from a cloud based DCG, owned by a third party for example, while only disclosing the parts of the local context (e.g. resources available, DCG state, task and model objective, data classification), as needed. This enables flexible and scalable integration of statistical, machine learning and artificial intelligence and simulation models into software applications, supported by a dynamic and adaptive federated DCG architecture that supports execution of data flows and orchestration of resources across cloud (e.g., hyperscale), self-managed (e.g., traditional data center) compute clusters, CDNs (e.g., forward content distribution networks that may expand from historical distribution of web content into forward hosting of data sets, models, AI tools, etc. . . . ), edge devices, wearables and mobile devices, and individual computers. For example, with the rise of edge computing for AI tasks a federated DCG could offload all or parts computationally intensive tasks from a mobile device to cloud compute clusters to more efficiently use and extend battery life for personal, wearable or other edge devices. According to another embodiment, workloads may be split across the federated DCG based on data classification. For example, only process Personally identifiable information (PII) or Protected Health Information (PHI) on private compute resources, but offload other parts of the workload, with less sensitive data, to public compute resources (e.g. those meeting certain security and transparency requirements).

In an embodiment, the federated distributed computational graph (DCG) system enables a sophisticated approach to distributed computing, where computational graphs are encoded and communicated across devices alongside other essential data. This data may include application-specific information, machine learning models, datasets, or model weightings. The system's design allows for the seamless integration of diverse computational resources.

The federated DCG facilitates system-wide execution with a unique capability for decentralized and partially blind execution across various tiers and tessellations of computing resources. This architecture renders partially observable, collaborative, yet decentralized and distributed computing possible for complex processing and task flows. The system employs a multi-faceted approach to resource allocation and task distribution, utilizing rules, scores, weightings, market/bid mechanisms, or optimization and planning-based selection processes. These selection methods can be applied at local, regional, or global levels within the system, where “global” refers to the entirety of the interconnected federated DCG network, regardless of the physical location or orbital position of its components.

This approach to federated computing allows for unprecedented flexibility and scalability. It can adapt to the unique challenges posed by diverse computing environments, from traditional terrestrial networks to the high-latency, intermittent connections characteristic of space-based systems. The ability to operate with partial blindness and decentralized execution is particularly valuable in scenarios where complete information sharing is impossible or undesirable due to security concerns, bandwidth limitations, or the physical constraints of long-distance space communications.

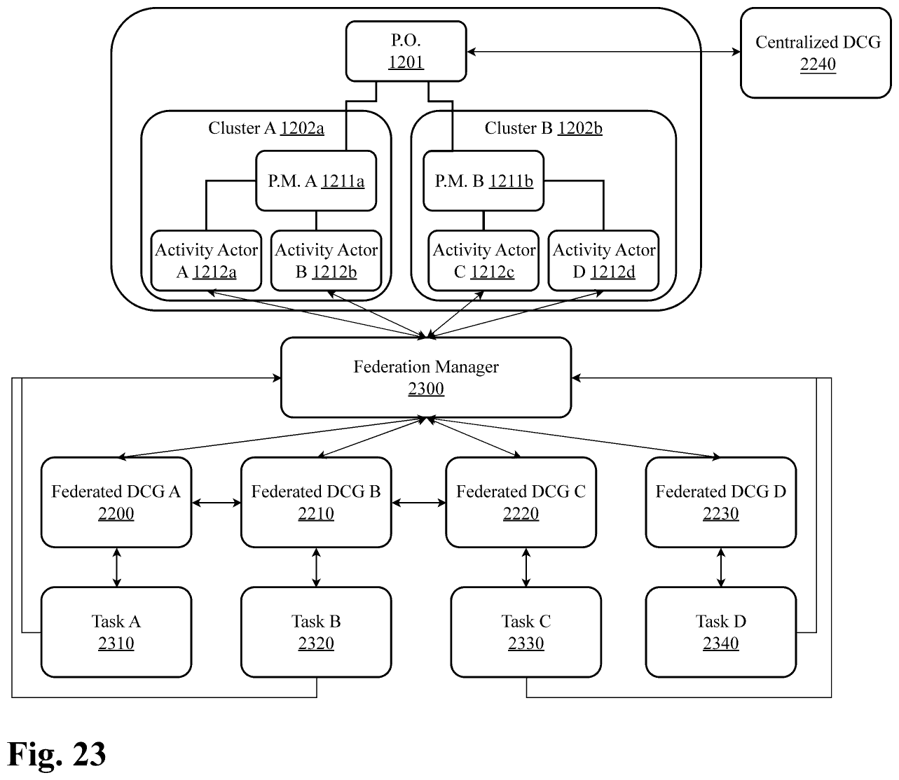

FIG. 23 is a block diagram illustrating an exemplary system architecture for a federated distributed graph-based computing platform that includes a federation manager. In one embodiment, a federation manager 2300 serves as an intermediary between the DCG 2240 and the federated DCGs (2200, 2210, 2220, 2230), providing a more sophisticated mechanism for orchestrating the federated system. It assumes some of the coordination responsibilities previously handled by the centralized DCG, allowing for more nuanced management of resources, tasks, and data flows across the federation. In this structure, DCG 2240 communicates high-level directives and overall system goals to the federation manager 2300. The Federation manager 2300 may be specified or dynamically elected from the participating DCGs. The Federation manager 2300 may be implemented through several different embodiments for leader election and management. In one embodiment, the system uses a gossip-based ring management similar to Riak Core, where participating DCGs form a ring structure and use gossip protocols to maintain and update cluster state information. This approach enables decentralized leader election while also sharing observability data about available resources, including CPU/GPU capabilities.

In another embodiment, the system implements a coordinated leader election mechanism similar to Kubernetes' approach, where election occurs across a tier or tessellation of resources. This implementation includes sharing of resource descriptions and operational metrics during the election process, allowing for informed selection of federation managers based on both node capabilities and current resource states. In another embodiment, the system utilizes a ZooKeeper-style quorum based approach for leader election and state management. This approach maintains consistency through distributed consensus while enabling the sharing of detailed resource descriptions and operational metrics across the federation. Additionally, the system may implement an Elasticsearch-style discovery and voting mechanism, where nodes participate in master election while simultaneously sharing information about their processing capabilities, security clearances, and available resources. This approach combines leader election with dynamic resource discovery and state management. In each embodiment, the gossiping protocol and leader election process, whether process-centric, tier-centric, or tessellation-centric, includes mechanisms for sharing observability data and detailed resource descriptions. This includes but is not limited to information about types of processes nodes can handle, available CPU/GPU resources, memory and storage capabilities, network bandwidth and latency metrics, security standards and privacy certifications, current resource utilization levels, and historical performance metrics. This rich metadata enables more intelligent federation management and resource allocation decisions while maintaining appropriate security and privacy boundaries.

Federation manager 2300 may then translate these directives into specific actions and assignments for each federated DCG, taking into account their individual capabilities, current workloads, and privacy requirements. Additionally, federation manager 2300 may also operate in the reverse direction, aggregating and relaying information from federated DCGs back to DCG 2240. This bi-directional communication allows federation manager 2300 to provide real-time updates on task progress, resource utilization, and any issues or anomalies encountered within the federated network. By consolidating and filtering this information, federation manager 2300 enables centralized DCG 2240 to maintain an up-to-date overview of the entire system's state without being overwhelmed by low-level details. This two-way flow of information facilitates adaptive decision-making at the centralized level while preserving the autonomy and efficiency of individual federated DCGs, ensuring a balanced and responsive federated computing environment

In an embodiment, federation manager 2300 may be connected to a plurality of pipeline mangers 1211a and 1211b, which are in turn connected to a pipeline orchestrator 1201. This connection allows for the smooth flow of information between each of the various hierarchies, or tessellations, within the system. Federation manager 2300 may also oversees the distribution and execution of tasks 2310, 2320, 2330, 2340 across the federated DCGs. It can break down complex workflows into subtasks, assigning them to appropriate federated DCGs based on their specializations, available resources, and security clearances. This granular task management allows for more efficient utilization of the federated system's resources while maintaining strict control over sensitive operations.

Federation manager 2300 may allocate tasks and transmit information in accordance with privacy and security protocols. It may act as a gatekeeper, controlling the flow of information between federated DCGs and ensuring that data sharing complies with predefined privacy policies. For instance, it could facilitate secure multi-party computations, allowing federated DCGs to collaborate on tasks without directly sharing sensitive data. Federation manager 2300 may also enable more dynamic and adaptive resource allocation. It can monitor the performance and status of each federated DCG in real-time, reallocating tasks or resources as needed to optimize overall system performance. This flexibility allows the system to respond more effectively to changing workloads or unforeseen challenges.

By centralizing federation management functions, this architecture provides a clearer separation of concerns between global coordination (handled by centralized DCG 2240) and local execution (managed by individual federated DCGs). This separation enhances the system's scalability and makes it easier to integrate new federated DCGs or modify existing ones without disrupting the entire federation.

In one embodiment, the federated DCG system can be applied to various real-world scenarios. In healthcare, multiple hospitals and research institutions can collaborate on improving diagnostic models for rare diseases while maintaining patient data confidentiality. Each node (hospital or clinic) processes patient data locally, sharing only aggregated model updates or anonymized features, allowing for the creation of a global diagnostic model without compromising individual patient privacy. In financial fraud detection, competing banks can participate in a collaborative initiative without directly sharing sensitive customer transaction data. The system enables banks to maintain local observability of their transactions while contributing to a shared fraud detection model using techniques like homomorphic encryption or secure multi-party computation. For smart city initiatives, the system allows various entities (e.g., transportation authorities, environmental monitors, energy providers) to collaborate while respecting data privacy. Each entity processes its sensor data locally, with the system orchestrating cross-domain collaboration by enabling cross-institution model learning without full observability of the underlying data.

In one embodiment, the federated DCG system is designed to support partial observability and even blind execution across various tiers and tessellations of computing resources. This architecture enables partially observable, collaborative, yet decentralized and distributed computing for complex processing and task flows. The system can generate custom compute graphs for each federated DCG, specifically constructed to limit information flow. A federated DCG might receive a compute graph representing only a fraction of the overall computation, with placeholders or encrypted sections for parts it should not access directly. This allows for complex, collaborative computations where different parts of the system have varying levels of visibility into the overall task. For instance, a federated DCG in a highly secure environment might perform critical computations without full knowledge of how its output will be used, while another might aggregate results without access to the raw data they're derived from.

In one embodiment, the federated DCG system is designed to seamlessly integrate diverse computational resources, ranging from edge devices to cloud systems. It can adapt to the unique challenges posed by these varied environments, from traditional terrestrial networks to high-latency, intermittent connections characteristic of space-based systems. The system's ability to operate with partial blindness and decentralized execution is particularly valuable in scenarios where complete information sharing is impossible or undesirable due to security concerns, bandwidth limitations, or physical constraints of long-distance communications. This flexibility allows the system to efficiently manage workloads across a spectrum of computing resources, from mobile devices and IoT sensors to edge computing nodes and cloud data centers.

In one embodiment, the system employs a multi-faceted approach to resource allocation and task distribution, utilizing rules, scores, weightings, market/bid mechanisms, or optimization and planning-based selection processes. These selection methods can be applied at local, regional, or global levels within the system. This approach allows the federated DCG to dynamically adjust to varying privacy and security requirements across different domains and use cases. For example, the system can implement tiered observability, where allied entities may have different levels of data-sharing access depending on treaties or bilateral agreements. This enables dynamic privacy management, allowing the system to adapt to changing regulatory landscapes or shifts in data sharing policies among collaborating entities.

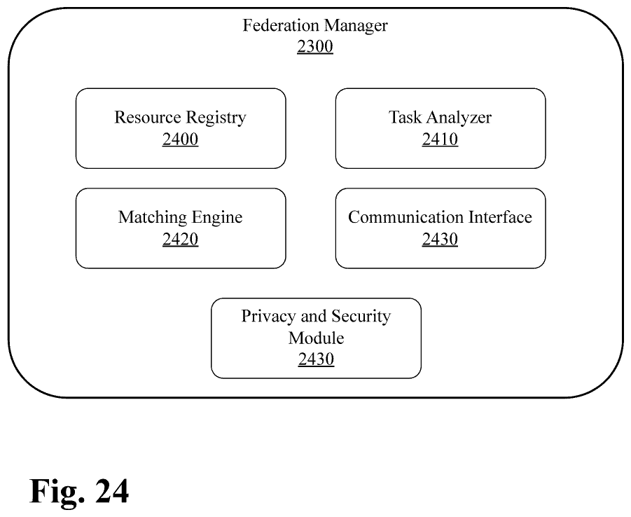

FIG. 24 is a block diagram illustrating an exemplary component of a federated distributed graph-based computing platform that includes a federation manager, the federation manager. In one embodiment, a resource registry 2400 maintains a dynamic inventory of available resources across all federated DCGs. This may be accomplished by periodically polling each federated DCG for updates on their computational capacity, storage availability, and current workload. This information is stored in a structured database, allowing for quick querying and analysis. The registry may use a gossip protocol to efficiently propagate updates across the federation, ensuring that resource information remains current even in large-scale deployments.

A task analyzer 2410 examines incoming tasks from the centralized DCG 2240 or from federated DCGs, breaking them down into subtasks and determining their requirements. It achieves this by parsing task descriptions, which may be encoded in a domain-specific language, and creating a directed acyclic graph (DAG) representing the task's structure and dependencies. The analyzer may also provide estimates regarding resource requirements for each subtask based on historical data and predefined heuristics.

A matching engine 2420 aligns tasks with appropriate federated DCGs by cross-referencing task requirements from task analyzer 2410 with available resources that have been documented by resource registry 2400. In one embodiment, matching engine may employ algorithms such as constraint satisfaction solvers or machine learning models, to optimize task distribution. The engine 2420 considers factors such as but not limited to data locality, processing power requirements, and privacy constraints when making matching decisions. It may use a scoring system to rank potential matches, selecting the highest-scoring options for task assignment.

A communication interface 2430 facilitates secure and efficient information exchange between federation manager 2300, centralized DCG 2240, and federated DCGs. It implements various communication protocols (e.g., gRPC, MQTT) to accommodate different network conditions and security requirements. The interface may encrypt data transfers and may employ techniques like zero-knowledge proofs for sensitive communications, allowing entities to verify information without revealing underlying data.

A privacy and security module 2440 enforces data protection policies across the federation. It achieves this by maintaining a set of rules and permissions for each federated DCG and task. When a task is assigned, this module checks the security clearance of the target federated DCG against the task's requirements. It may implement differential privacy techniques, adding controlled noise to data or results to prevent the extraction of individual information. For collaborative tasks, it could set up secure multi-party computation protocols, enabling federated DCGs to jointly compute results without sharing raw data.

In a decentralized, blind or double blind embodiments, DCG 2240 encodes high-level computational tasks into graphs that can be distributed across the federation. However, unlike traditional distributed systems, these graphs are designed to be partitioned and obscured, allowing for partial or even blind execution. Federation manager 2300 receives computational graphs from DCG 2240, and breaks down the graphs into subtasks which are designed to be executable with limited context. Matching engine 2420 then allocates these subtasks to federated DCGs 2200, 2210, 2220, 2230 based not just on their capabilities, but also on their clearance levels and need-to-know basis.

For each federated DCG, the system may generate a custom compute graph. These graphs are not merely simplified versions of the original, but are specifically constructed to limit information flow. A federated DCG might receive a compute graph that represents only a fraction of the overall computation, with placeholders or encrypted sections representing parts of the computation it should not have direct access to. Communication interface 2430 securely transmits these tailored compute graphs to the federated DCGs through the pipeline structure 1201. This transmission process itself can incorporate encryption and access control mechanisms to maintain the partial blindness of the execution.

Within each federated DCG, the activity actors 1212a-d perform computations based on their received graph, potentially without full knowledge of the overall task they're contributing to. This blind or partially blind execution may be managed by the local pipeline orchestrator 1201, which ensures that each component only accesses the information it's cleared for. The system's ability to operate with partial observability comes into play as computations progress. Federated DCGs report results back through the pipeline structure, but these results may be encrypted or obfuscated to maintain partial blindness. This architecture allows for complex, collaborative computations where different parts of the system have varying levels of visibility into the overall task. For instance, a federated DCG in a highly secure environment might perform critical computations without full knowledge of how its output will be used, while another federated DCG might aggregate results without access to the raw data they're derived from.

By enabling this decentralized, partially blind execution, the federated DCG system can tackle complex computational tasks that span entire networks, while maintaining strict control over information flow and resource utilization. This approach is particularly valuable for scenarios involving sensitive data, limited communication bandwidth, or the need for compartmentalized computing across vast distances in space.

In one embodiment, the system implements dynamic task allocation based on real-time conditions and changing requirements. As computations progress, each federated DCG reports back through the pipeline structure, providing feedback on task progress, resource utilization, and any issues encountered. The federation manager aggregates this information, providing a high-level overview of the system's state. Based on this real-time feedback, the system can dynamically adjust compute graphs and task allocations. It might modify compute graphs in real-time, reassign tasks to different federated nodes, or adjust resource allocations in response to changing workloads or unforeseen challenges. This adaptive process ensures efficient utilization of resources across the entire federated system, from terrestrial networks to space-based computing nodes, allowing the system to respond effectively to changing conditions and requirements in real-time while maintaining security and efficiency.

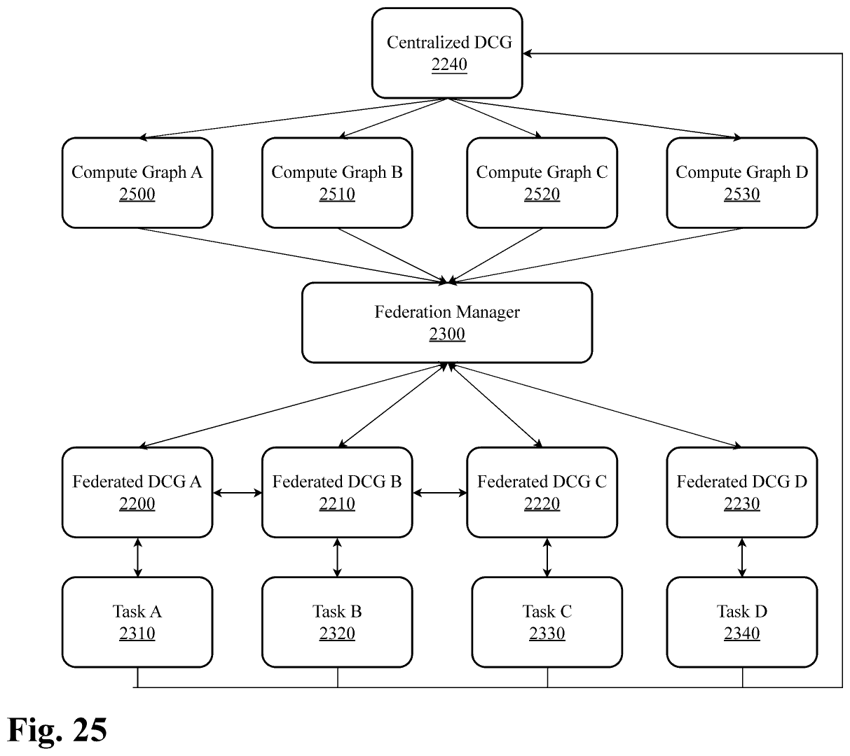

FIG. 25 is a block diagram illustrating an exemplary system architecture for a federated distributed graph-based computing platform that includes a federation manager where different compute graphs are forward to various federated distributed computation graph systems. In one embodiment, DCG 2240 generates a plurality of compute graphs 2500, 2510, 2520, 2530 tailored to each federated DCG's requirements and specifications. This approach allows for fine-grained control over information access and task execution across the federation. DCG 4940 analyzes the overall task requirements and the characteristics of each federated DCG 2200, 2210, 2220, 2230, considering factors such as but not limited to processing capabilities, data access permissions, security clearance levels, and specialized functions. Based on this analysis, it constructs custom compute graphs for each Federated DCG through a multi-step process that involves creating a master compute graph, applying transformations based on each DCG's specifications, and potentially replacing sensitive operations with privacy-preserving alternatives.

Federation manager 2300 may provide the DCG 2240 with up-to-date information about each federated DCG's current status, capabilities, and access rights by leveraging the pipeline infrastructure. This information is used to dynamically adjust the compute graphs as conditions change. When distributing tasks 2310, 2320, 2330, 2340, centralized DCG 2240 sends the corresponding compute graph along with the task, serving as a blueprint for how the federated DCG should execute the task, specifying data access, operations, and handling of intermediate results.

Compute graphs may also be used to facilitate secure collaboration between federated DCGs, potentially including special nodes that define how intermediate results should be shared or combined without revealing sensitive information. As federated DCGs execute their tasks according to their assigned compute graphs, they report progress back to federation manager 2300. Federation manager may then update DCG 2240, which may decide to modify the compute graphs in real-time if necessary, such as when new data requires additional processing steps or if a security policy changes mid-execution.

This dynamic, graph-based approach allows the system to maintain strict control over information flow and task execution while still leveraging the full capabilities of the federated architecture. It provides a flexible framework for handling complex, distributed tasks with varying security and privacy requirements across heterogeneous computing environments, enabling the system to adapt to changing conditions and requirements in real-time while maintaining security and efficiency.

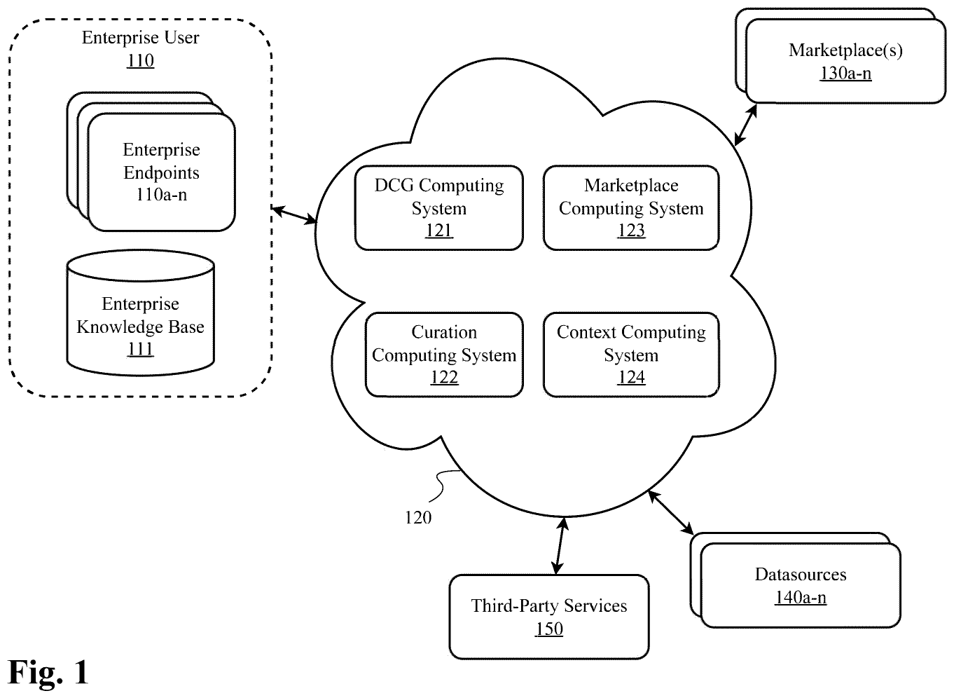

FIG. 1 is a block diagram illustrating an exemplary system architecture for a distributed generative artificial intelligence reasoning and action platform 120, according to an embodiment. According to the embodiment, platform 120 is configured as a cloud-based computing platform comprising various system or sub-system components configured to provide functionality directed to the execution of neuro-symbolic generative AI reasoning and action. Exemplary platform systems can include a distributed computational graph (DCG) computing system 121, a curation computing system 122, a marketplace computing system 123, and a context computing system 124. In some embodiments, systems 121-124 may each be implemented as standalone software applications or as a services/microservices architecture which can be deployed (via platform 120) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker and orchestrated using container orchestration platforms like Kubernetes. This allows for easier deployment and management of services.

The distributed generative AI reasoning and action platform 120 can enable a more flexible approach to incorporating machine learning (ML) models into the future of the Internet and software applications; all facilitated by a DCG architecture capable of dynamically selecting, creating, and incorporating trained models with external data sources and marketplaces for data and algorithms.

According to the embodiment, DCG computing system 121 provides orchestration of complex, user-defined workflows built upon a declarative framework which can allow an enterprise user 110 to construct such workflows using modular components which can be arranged to suit the use case of the enterprise user. As a simple example, an enterprise user 110 can create a workflow such that platform 120 can extract, transform, and load enterprise-specific data to be used as contextual data for creating and training a ML or AI model. The DCG functionality can be extended such that an enterprise user can create a complex workflow directed to the creation, deployment, and ongoing refinement of a trained model (e.g., LLM). For example, in some embodiments, an enterprise user 110 can select an algorithm from which to create the trained model, and what type of data and from what source they wish to use as training data. DCG computing system 121 can take this information and automatically create the workflow, with all the requisite data pipelines, to enable the retrieval of the appropriate data from the appropriate data sources, the processing/preprocessing of the obtained data to be used as inputs into the selected algorithm(s), the training loop to iteratively train the selected algorithms including model validation and testing steps, deploying the trained model, and finally continuously refining the model over time to improve performance.

A context computing system 124 is present and configured to receive, retrieve, or otherwise obtain a plurality of context data from various sources including, but not limited to, enterprise users 110, marketplaces 130a-n, third-party sources 150, and other data sources 140a-n. Context computing system 124 may be configured to store obtained contextual data in a data store. For example, context data obtained from various enterprise endpoints 110a-n of a first enterprise may be stored separately from the context data obtained from the endpoints of a second enterprise. In some embodiments, context data may be aggregated from multiple enterprises within the same industry and stored as a single corpus of contextual data. In such embodiments, contextual data may be transformed prior to processing and storage so as to protect any potential private information or enterprise-specific secret knowledge that the enterprise does not wish to share.

A curation computing system 122 is present and configured to provide curated (or not) responses from a trained model (e.g., LLM) to received user queries. A curated response may indicate that it has been filtered, such as to remove personal identifying information or to remove extraneous information from the response, or it may indicate that the response has been augmented with additional context or information relevant to the user. In some embodiments, multiple trained models (e.g., LLMs) may each produce a response to a given prompt, which may include additional contextual data/elements, and a curation step may include selecting a single response of the multiple responses to send to a user, or the curation may involve curating the multiple responses into a single response. The curation of a response may be based on rules or policies that can set an individual user level, an enterprise level, or at a department level for enterprises with multiple departments (e.g., sales, marketing, research, product development, etc.).

According to the embodiment, an enterprise user 110 may refer to a business organization or company. An enterprise may wish to incorporate a trained ML model into their business processes. An enterprise may comprise a plurality of enterprise endpoints 110a-n which can include, but are not limited to, mobile devices, workstations, laptops, personal computers, servers, switches, routers, industrial equipment, gateways, smart wearables, Internet-of-Things (IoT) devices, sensors, and/or the like. An enterprise may engage with platform 120 to create a trained model to integrate with its business processes via one or more enterprise endpoints. To facilitate the creation of purpose-built, trained models, enterprise user 110 can provide a plurality of enterprise knowledge 111 which can be leveraged to build enterprise specific (or even specific to certain departments within the enterprise) ML/AI models. Enterprise knowledge 111 may refer to documents or other information important for the operation and success of an enterprise. Data from internal systems and databases, such as customer relationship management (CRM) systems, enterprise resource planning (ERP) systems, rules and policies databases, and transactional databases, can provide information about the operational context of an enterprise. For example, product knowledge, market knowledge, industry trends, regulatory knowledge, business processes, customer knowledge, technology knowledge, financial knowledge, organization knowledge, and risk management knowledge may be included in enterprise knowledge base 111.

According to the embodiment, platform 120 is configured to retrieve, receive, or otherwise obtain a plurality of data from various sources. A plurality of marketplaces 130a-n may be present and configured to provide centralized repositories for data, algorithms, and expert judgment, which can be purchased, sold, or traded on an open marketplace. External data sourced from various marketplaces 130a-n can be used as a training data source for creating trained models for a particular use case. A marketplace computing system 123 is present and configured to develop and integrate various marketplaces 130a-n. Marketplace computing system 123 can provide functionality directed to the registration of experts or entities. An expert may be someone who has a deep understanding and knowledge of a specific industry, including its trends, challenges, technologies, regulations, and best practices. Industry experts often have many years of experience working in the industry and have developed a reputation for their expertise and insights. Examples of experts can include, but are not limited to, consultants, analysts, researchers, academics, or professionals working in the industry. In some embodiments, experts and/or entities can register with platform 120 so that they may become verified experts/entities. In such an embodiment, an expert/entity profile may be created which can provide information about expert judgment, scored data and algorithms, and comparisons/statistics about the expert's/entity's scores and judgment with respect to other expert/entities. Marketplace computing system 123 may further provide functionality directed to the management of the various marketplaces and the data/algorithms provided therein.

According to some embodiments, platform 120 can communicate with and obtain data from various third-party services 150. For example, third-party services can include LLM services such as APIs and LLM hosting platforms, which platform 120 can interface with to obtain algorithms or models to use as starting points for training a neuro-symbolic generative AI reasoning and action model to be deployed at the enterprise or individual level. As another example, social media platforms can provide data about trends, events, and public sentiment, which can be useful for understanding the social context of a situation. Exemplary data sources 140a-n can include, but are not limited to, sensors, web data, environmental data, and survey and interviews.

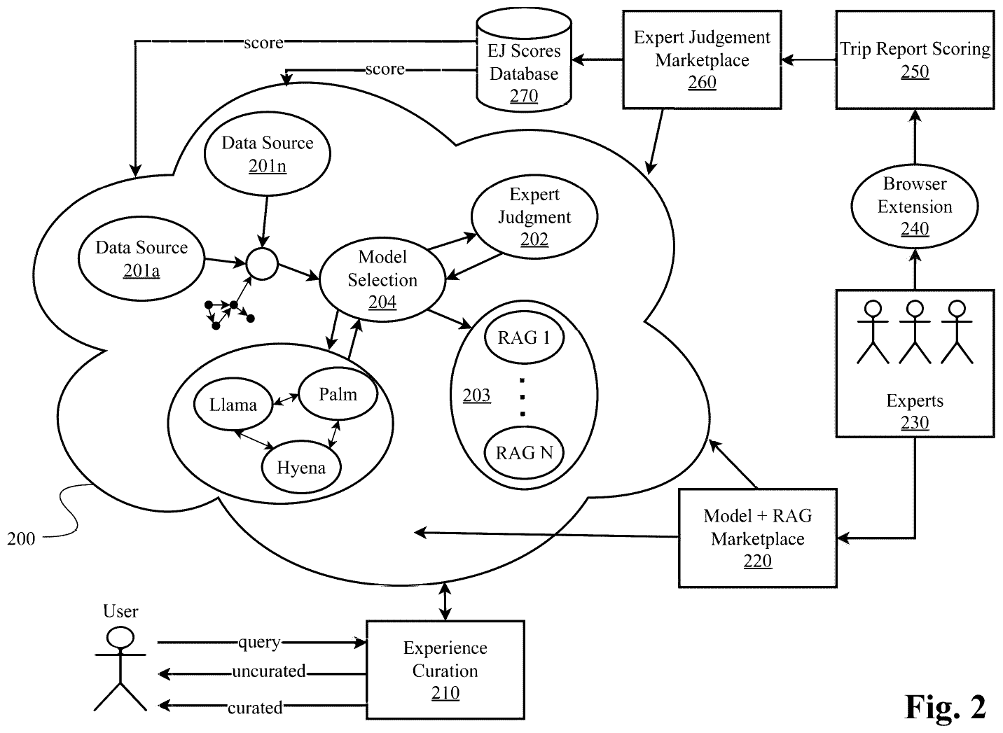

FIG. 2 is a block diagram illustrating an exemplary aspect of a distributed generative AI reasoning and action platform incorporating various additional contextual data. According to the aspect, a plurality of contextual data from various data sources may be integrated into platform 120. A simple exemplary directed computational graph 200 is illustrated within the cloud and utilizing the plurality of contextual data to create and train a model. Various marketplaces 130a-n are shown which can provide contextual data to platform 120 including an expert judgment marketplace 260 and a model and retrieval augmented generation (RAG) marketplace 220. According to the aspect, DCG 200 orchestrates model (and model weight) selection 204, including multi-model usage in series or parallel (i.e., feed output of one model into another, or compare and choose outputs across multiple models), based on multiple data sources (both trained and external), input from crowdsourced expert judgment, training or tuning data set corpora, and RAG libraries.

Expert judgment will become increasingly important in the world of proprietary or otherwise blackbox ML or AI models where hallucinations and training data quality may produce misleading or otherwise incorrect results. The expert judgment marketplace 260 provides a way for experts 230 to weigh-in on the correctness of data whether that is training data or model output, and can be facilitated by a browser extension 240, for example, to score things like data sources during their daily “trip around web”. This trip report scoring 250 concept allows experts to score data sources. In an implementation, a browser extension 240 is developed with an accuracy score input where the user can rank a news article they are reading as they consume it. Expert judgment marketplace 260 allows for consumers to pick and rank “experts” based on how well their judgment helps or hinders their overall consumption of model output. For example, experts that routinely highly rank data sources, like news sites, that are known to spread false information should likewise be less trusted over time compared to their peers, and any models trained on that data similarly less trusted. Ultimately a database 270 of data sources and schemas scored by algorithms or experts could be used as input into the DCG 200 for more accurate and real-time inference based on ongoing rating of preferred data set and data format combinations (e.g. the same data might be purchased in unstructured, structured, schematized, normalized, or semantified formats) which may introduce different types of bias or impacts on performance, results, or processing costs.

Accordingly, a RAG marketplace 220 may be implemented to further refine model output. RAG input information may be included as additional context which can be supplied to a GenAI model in addition to a prompt (engineered, or otherwise). Marketplace 220 may be global or local to a given device or system since they might cache resources locally for on demand purchase or execution. This is especially important where companies may want to sell access to their proprietary dataset through the form of input to a RAG. For example, a medical research company may have valuable information they could sell to other institutions in the form of the output of their dataset fed to a RAG to augment related research without specifically providing access to the raw training data. Retrieval-augmented generation is a framework that combines elements of retrieval-based and generative models to improve the performance of natural language processing tasks. In RAG, a retriever component is used to select relevant information from a large corpus, and a generator component is used to produce a final output based on both the retrieved information and the input query. RAG marketplace 220 may be scored by experts for accuracy and effectiveness across domains. The owner of these datasets may also further protect raw data access while also increasing retrieval accuracy by developing a set of models trained for each AI model that can allow retrieved data to be projected into a latent space capable of being fed into a specific AI model. This approach may leverage techniques such as autoencoders, Variational Autoencoders (VAEs), or adversarial training to create lower-dimensional representations that capture essential features while obscuring raw data. These latent representations can be tailored to specific AI tasks, providing just enough information for the model to perform effectively without exposing unnecessary details. This latent representation of data would prevent the user from reversing it back to raw data, while also being designed to efficiently inform the selected AI model. Furthermore, by applying dimensionality reduction techniques like t-SNE or UMAP, and incorporating differential privacy methods, the system can offer formal privacy guarantees while maintaining data utility. This strategy allows for a balance between protecting sensitive information and enabling high-performance AI applications, as each latent space can be optimized for its intended use case while minimizing the risk of data reconstruction.

According to the aspect, a user experience curation engine 210 is needed that is able to curate output whether that is in the form of filtering out sensitive data or simply customizing results in a way the user prefers (which may be based on user-/entity-defined rules or policies). A user can submit a query to experience curation engine 210 which can send the query to the DCG trained model to obtain a response. Experience curation 210 may then process the received response to curate it (or not) to meet the preferences of the user.

As illustrated, DCG 200 shows a simple example of a directed computational graph which can be used to create a complex workflow to create and train an MI/AI model (e.g., variations of or standard transformer architecture). A shown, the DCG comprises multiple sources of information for training the selected models(s) including multiple data sources 201a-n which may or may not be scored by experts, expert judgment 202, and one or more RAGs 203 which may be obtained from RAG marketplace 220 or may be obtained directly from enterprise knowledge. DCG may have access to stored models or variants thereof. In the illustration, LLAMA (Learned Layer-wise Attention Metric for Transformers), PALM (Permuted Adaptive Lateral Modulation), and HYENA (Hyperbolic Encoder for Efficient Attention) are shown as possible examples of the types of models which can be selected by the DCG to create and train a GenAI model. Furthermore, the “model parameters” and mathematical techniques or assumptions used in each model may be cataloged and included in a model-specific template which may be stored in cloud-based storage on platform 120. In some embodiments, platform 120 may store a hierarchical representation of transformer models (e.g., as a graph), which may represent a lineage of the evolution of transformer models. In an implementation, model selection or exploration involves selections based on the evolutionary tree of one or more model types and use said tree (e.g., graph) for selections in heuristic search for best algorithm/data combinations, licensing costs/explorations, etc. It should be appreciated that certain aspects of the invention may be tailored based on what kind of mathematical approach underpins a specific model.

In operation, DCG 200 obtains the various contextual data from the connected data sources, creates training, validation, and test datasets from the obtained data, and uses the various datasets to train, validate, and test the model as it undergoes a model training loop that iteratively trains the model to generate responses based on the plurality of contextual data.

FIG. 3 is a diagram illustrating incorporating symbolic reasoning in support of LLM-based generative AI, according to an aspect of a neuro-symbolic generative AI reasoning and action platform. According to the aspect, platform 120 can incorporate symbolic reasoning and in-context learning to create and train off the shelf models (e.g., an LLM foundational model or narrow model) through clever prompting and conditioning on private data or very situation specific “contextual” data. Platform 120 can obtain contextual data 301 and preprocess the data for storage. Contextual data 301 may refer to data obtained from marketplaces 130a-n, third-party services 150, and enterprise knowledge 111, as well as other types of contextual data that may be obtained from other sources. DCG 330 is responsible for orchestrating the entire process and can create data pipelines 310 as needed to facilitate the ingestion of contextual data 301. Contextual data can include text documents, PDFs, and even structure formats like CSV (comma-separated values) or SQL tables or other common generic data formats like OWL or RDF or domain specific content such as the Financial Industry Business Ontology (FIBO) or Open Graph of Information Technology (OGIT). This stage involves storing private data (e.g., context data) to be retrieved later.

Typically, the context data 301 is broken into chunks, passed through and embedding model 315, then stored in a specialized database called a vector database 320. Embedding models are a class of models used in many tasks such as natural language processing (NLP) to convert words, phrases, or documents into numerical representations (embeddings) that capture similarity which often correlates semantic meaning. Exemplary embedding models can include, but are not limited to, text-embedding-ada-002 model (i.e., OpenAI API), bidirectional encoder representations form transformers, Word2Vec, FastText, transformer-based models, and/or the like. The vector database 315 is responsible for efficiently storing, comparing, and retrieving a large plurality of embeddings (i.e., vectors). Vector database 315 may be any suitable vector database system known to those with skill in the art including, but not limited to, open source systems like Pinecone, Weaviate, Vespa, and Qdrant. According to the embodiment, embedding model 315 may also receive a user query from experience curation 340 and vectorize it where it may be stored in vector database 320. This provides another useful datapoint to provide deeper context when comparing received queries against stored query embeddings.

A user may submit a query 303 to an experience curation engine 340 which starts the prompt construction and retrieval process. The query is sent to DCG 330 which can send the query to various components such as prompt engineering 325 and embedding model 315. Embedding model 315 receives the query and vectorizes it and stores it in vector database 320. The vector database 320 can send contextual data (via vectors) to DCG 330 and to various APIs/plugins 335. Prompt engineering 325 can receive prompts 302 from developers to train the model on. These can include some sample outputs such as in few-shot prompting. The addition of prompts via prompt engineering 325 is designed to ground model responses in some source of truth and provide external context the model wasn't trained on. Other examples of prompt engineering that may be implemented in various embodiments include, but are not limited to, chain-of-thought, self-consistency, generated knowledge, tree of thoughts, directional stimulus, and/or the like.

During a prompt execution process, experience curation 340 can send user query to DCG 330 which can orchestrate the retrieval of context and a response. Using its declarative roots, DCG 330 can abstract away many of the details of prompt chaining; interfacing with external APIs 335 (including determining when an API call is needed); retrieving contextual data from vector databases 330; and maintaining memory across multiple LLM calls. The DCG output may be a prompt, or series of prompts, to submit to a language model via LLM services 360 (which may be potentially prompt tuned). In turn, the LLM processes the prompts, contextual data, and user query to generate a contextually aware response which can be sent to experience curation 340 where the response may be curated, or not, and returned to the user as output 304.

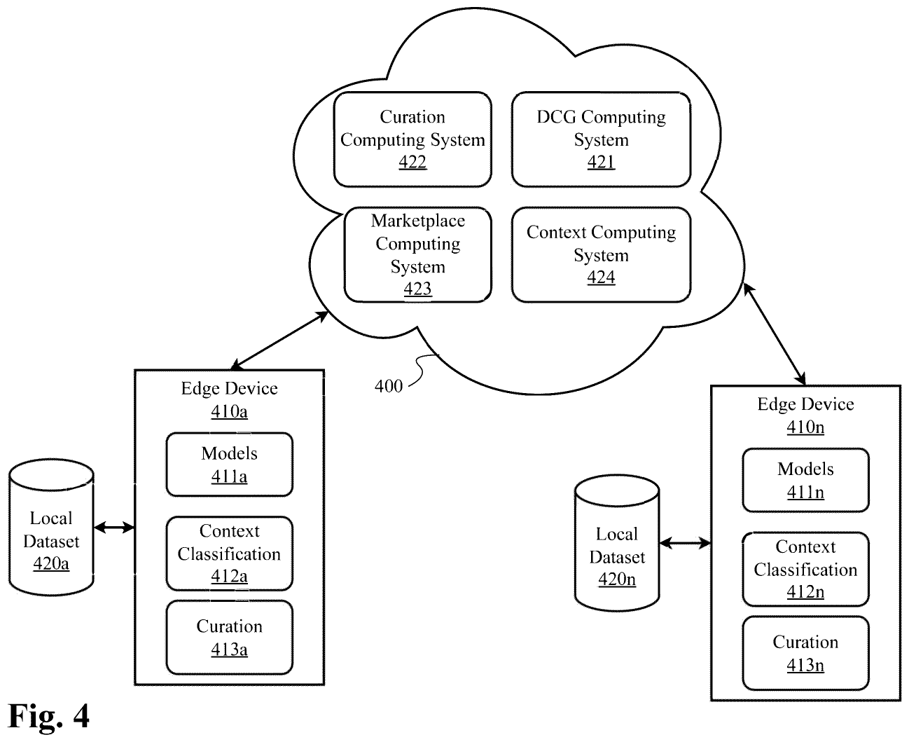

FIG. 4 is a block diagram illustrating an exemplary architecture for a neuro-symbolic generative AI reasoning and action platform 400 configured for federated learning at a plurality of edge devices 410a-n, according to an embodiment. According to the embodiment, platform 400 comprises DCH computing system 421, curation computing system 422, marketplace computing system 423, and context computing system 424. According to an embodiment, edge devices 410a-n may represent various enterprise endpoints. In other embodiments, edge devices 410a-n may represent various endpoints from two or more separate enterprises. In an embodiment, an edge device 410a-n may be a computing device associated with a platform user, such as someone who engages with the platform for experience curation or an expert who provides expert judgment scores to platform 400 via, for example, expert judgment marketplace 260 or some other mechanism.

As shown, each edge device 410a-n may comprise instances of local models 411a-n, context classification processes 412-n, and experience curation processes 413a operating on the device. Each edge device may have access to a local data or knowledge base 420a-n and which is only accessible by its associated edge device. Edge devices 410a-n may utilize these components to perform various computations wherein the processing of data and execution of algorithms happens locally on the device, rather than relying on the systems and services provided by platform 400. In some embodiments, a plurality of edge devices 410a-n may be implemented as individual computing nodes in a decentralized federated system, wherein tasks and data may be distributed across multiple nodes, allowing for parallel processing and potentially faster computation. Federated systems are often used in scenarios where data privacy and security are important, as data can remain on local nodes and only aggregated or processed results are shared more widely.

In some implementations, the platform 400 may leverage federated learning, where machine learning models 411a-n are trained across multiple decentralized edge devices 410a-n, with the models' updates being aggregated centrally. This approach allows for the training of models without the need to centrally store sensitive data from individual devices. For example, each edge device 410a-n could train local instances of neuro-symbolic GenAI reasoning and action models and local instances of context classification models 412a-n. According to an embodiment, context classification models 412a-n may be configured to select relevant passages from a knowledge base 420a-n or corpus given a query. This can be done using various techniques such as BM25, TF-IDF, or neural retrieval models like dense passage retrieval. The retrieved passages serve as context or input to a generator (e.g., a transformer-based model).

Federated learning can occur at the edge device wherein the context classification model 412a is trained locally. Periodically, (e.g., hourly, daily, weekly, etc.) platform 400 may collect (e.g., aggregate) model parameters, encrypted data, and/or the like from all of, or a subset of, edge devices 410a-n and apply the aggregated model parameters as an update to a master or global model (e.g., context classification, neuro-symbolic GenAI model,, etc.). The updated global model or just its parameters, may be transmitted to all of, or a subset of, the edge devices 410a-n where they may be applied to the local models operating thereon. Similarly, platform 400 can aggregate obtained training data, which may or may not be encrypted, and apply the training data to global models. These updated models may be transmitted to edge devices as described above.

As shown, edge devices 410a-n may further comprise a curation application 413a-n operating on the device. Curation application 413a may be configured to act as an intermediary between a user who can submit a query and models 411a which receive the query and generate a response back. Curation 413a-n may receive a response from a locally stored model and curate the response based on user (or entity) defined rules or preferences. For example, a response may first be filtered of any personal information by curation 413a prior to the being relayed back to the user. As another example, curation 413a may transform the response into specific format, style, or language based on user defined preferences. This allows the edge device 410a user to have their experience with the local models curated to fit any criteria they deem important.

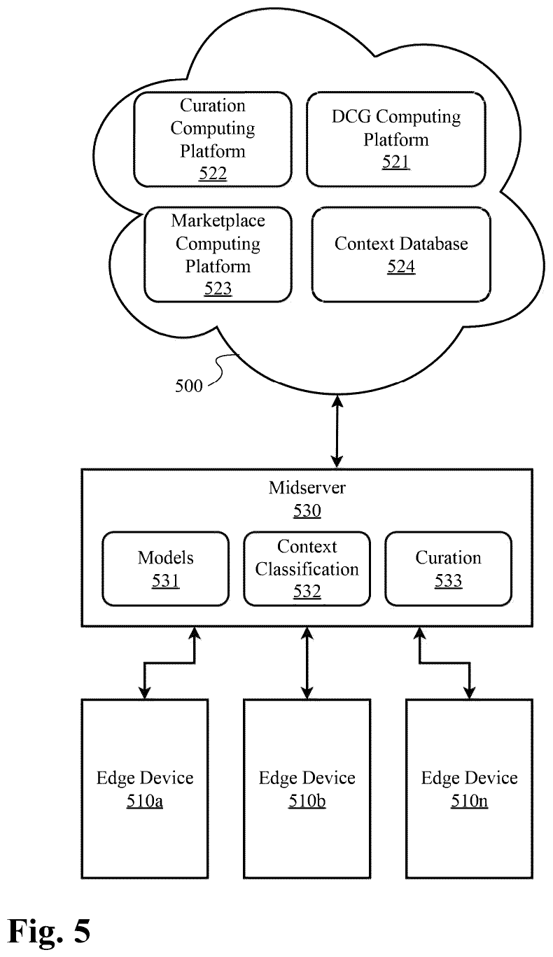

FIG. 5 is a block diagram illustrating an exemplary architecture for a neuro-symbolic generative AI reasoning and action platform 500 configured to utilize a midserver 530 to act as a computing intermediary between a plurality of edge devices 510a-n and the platform. According to the embodiment, midserver 530 facilitates communication between edge devices 510a-n and the backend systems 521, 522, 523, 524 provided by platform 500. The system supports any number of midservers, CDNs, or resource pools that can dynamically join and rejoin the network through gossip protocols across resource pools.

According to the embodiment, midserver 530 may have stored and operating on it one or more neuro-symbolic GenAI reasoning and action models 531, context classification processes 532, and curation processes 533. Each resource pool, including midserver 530, performs local forecasting of its future availability and reliability based on local information, advertising these predictions on both a real-time and forward-looking basis. This probabilistic forecasting at the resource pool level operates distinctly from the pool's reception of probabilistic information from other resource pools, enabling it to compute probabilistic representations of potential compute paths with partial observability to share back through the network.

Midserver 530 can be configured to periodically receive data (e.g., context data) and state information from each of the connected edge devices 510a-n. Each resource pool may independently validate the accuracy and authenticity of other pools' advertised resources and capabilities, implementing security measures similar to MANRS (Mutually Agreed Norms for Routing Security) to protect against spoofing, false advertisements, and other security threats across resource pool advertisements within or across counterparties, regardless of whether they share public, private, or hybrid data access patterns. Additionally, midserver 530 can be configured to receive user-submitted queries or data submissions or messages from edge devices via curation 533, obtain relevant context associated with the received query or message via context classification 532, and use a neuro-symbolic GenAI model 531 to process the query and context data to generate a response to the user. The generated response may be curated (or not) and transmitted back to the user of the edge device.

This functionality can be extended to support “reverse edge” computing scenarios, similar to Private Compute Cloud (PCC) concepts. For example, midserver 530 could be implemented as a hyperconverged appliance or software package deployed on-premises, akin to Azure Stack or AWS Outposts. In this configuration, it would act as a local, private cloud environment, hosting content curation systems and AI models closer to the data source. This approach allows for data processing, AI inferencing, and content curation to occur within the organization's own infrastructure, addressing data sovereignty, latency, and privacy concerns while still leveraging cloud-like capabilities. Edge devices and midservers may also receive or transmit entire DCG instruction sets which may be optionally bundled with models, RAG, weight adjustments, synthetic data sets, data, or logic. Edge devices and midservers may also receive or transmit entire DCG instruction sets which may be optionally bundled with models, RAG, weight adjustments, synthetic data sets, data, or logic.

In some implementations, edge devices 510a-n may have stored upon them local models as described in FIG. 4, and midserver 530 may store global models or even mid-tier models associated with the local models. In such an implementation, midserver can aggregate model parameters and update the global/mid-tier models accordingly.

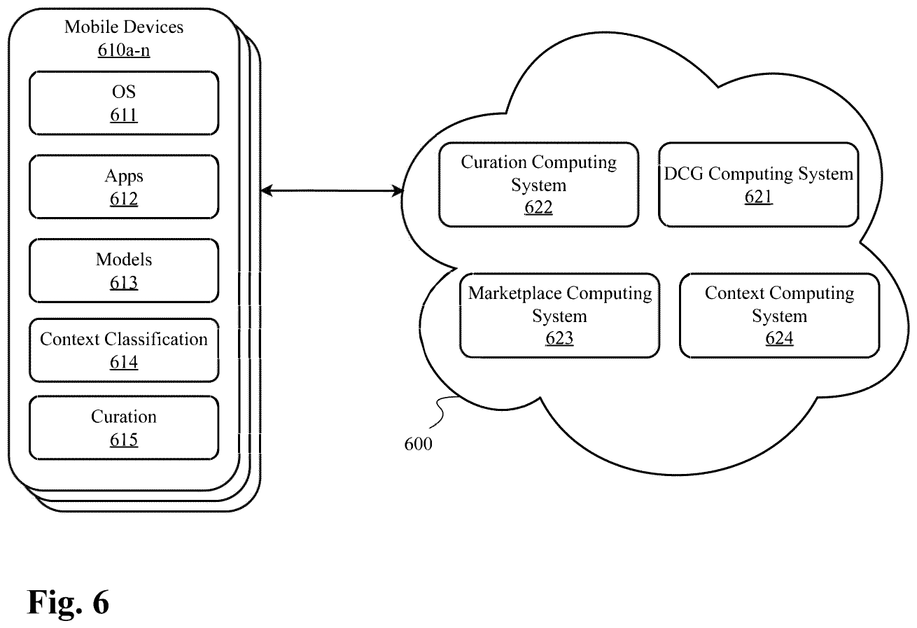

FIG. 6 is a block diagram illustrating an exemplary mobile device 610a-n configured for experience curation using embedded capabilities and functionality provided by a neuro-symbolic generative AI reasoning and action platform 600, according to an embodiment. According to the embodiment, a mobile device 610a may comprise an operating system 611, various software applications 612 (e.g., text messaging application, social media application, mobile games, music streaming applications, etc.), a local instance of a neuro-symbolic GenAI model 613, a context classification model 614, and an experience curation application 615. Mobile devices 610a-n may further comprise a processor, memory, sensors, storage, wireless communication modules, a display, audio components, and various other components to enable the functionality of a mobile computing device. Mobile devices 610a-n may connect to platform 600 via a suitable communication network such as the Internet. In some embodiments, mobile devices may utilize the systems and services 621, 622, 623, 624 provided by platform to facilitate query-response interactions with a neuro-symbolic GenAI model.

According to the embodiment, mobile device 610a stores and operates local models 613, 614 and a curation application 615 which can be leveraged during instances when mobile device 610a is unable to connect with platform 600 or otherwise has an intermittent connection thereby making data transmission difficult, slow, or impossible. In such situations, mobile device 610a can leverage the local components to perform computation at the edge. A user of mobile device 610a can use curation application 615 to submit a query to the local neuro-symbolic GenAI model 613, along with any aggregated context retrieved via context classification 614. The model 613 can generate a response and send it to curation application 615 where it may be curated (or not) based on the mobile device user's preferences or rules.

In some embodiments, when there is only an intermittent connection to platform 600, such as when a mobile device is in an area with poor network coverage, various strategies may be implemented to provide functionality to the mobile device user. For example, data (e.g., a user submitted query or prompt) can be temporarily stored in a buffer on the device until a connection to platform 600 is available. Once the connection is reestablished, the buffered data can be transmitted. Likewise, frequently accessed data or recently transmitted data can be cached on the device. This allows the device to access the data locally when a connection to platform 600 is not available. In some implementations, data can be compressed before transmission to reduce the amount of data that needs to be transmitted. This can help to minimize the impact of intermittent connections on data transmission. In some embodiments, mobile device 610a-n may use protocols that are designed to handle intermittent connections, such as MQTT (Message Queuing Telemetry Transport) or CoAP (Constrained Application Protocol), can help to ensure that data is successfully transmitted even in challenging network conditions. Finally, some use cases may implement an offline mode that allows users to continue using the application (or local instances) and storing data locally until a connection to platform 600 is available again.

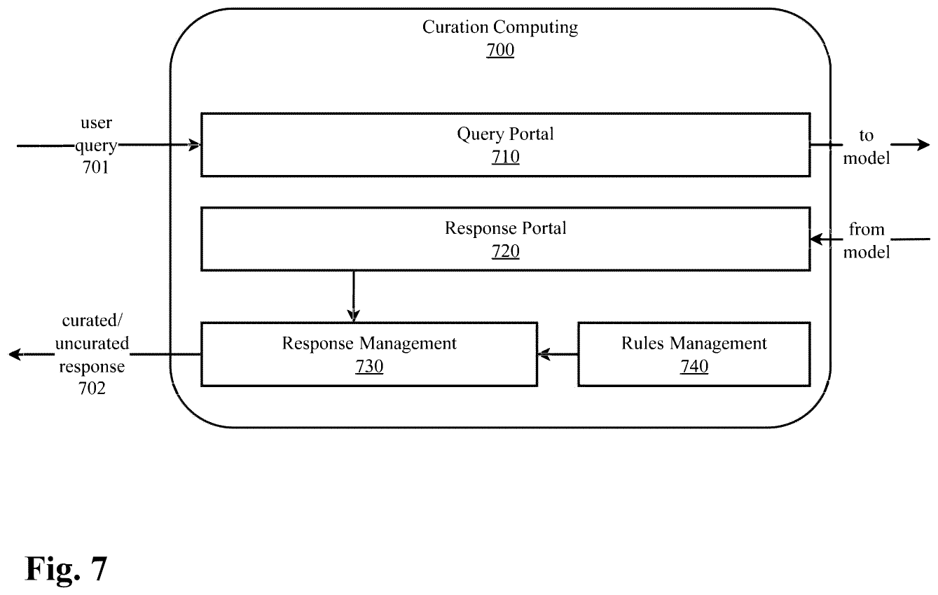

FIG. 7 is a block diagram illustrating an exemplary aspect of a distributed generative artificial intelligence reasoning and action platform, a curation computing system 700. According to the aspect, curation computing system 700 is configured to provide curated (or not) responses from a trained model (e.g., transformer-based model) to received user queries. A curated response may indicate that the response has been filtered, such as to remove personal identifying information or to remove extraneous information from the response, or it may indicate that the response has been augmented with additional context or information relevant to the user. The curation of a response may be based on rules or policies that can be set at an individual user level, an enterprise level, or at a department level for enterprises with multiple departments (e.g., sales, marketing, research, product development, etc.). User/entity rules and/or preferences may be stored in a data storage system of platform 120 and retrieved by a rules management component 740 during experience curation processes.

In operation, curation computing 700 receives a user query 701 directed to a neuro-symbolic GenAI model. A query portal 710 may be present and configured to receive a query 701 and prepare it for processing by a GenAI model. For example, a query may be split into tokens, (e.g., words or sub words) which are basic units of the language model. As another example, a text-based query may undergo normalization (e.g., converting to lowercase, removing punctuation, handling special characters, etc.) to ensure consistency and improve model performance. As yet another example, for models that use attention mechanisms, an attention mask may be applied to the input to indicate which tokens should be attended to and which should be ignored. In some implementations, a query portal 710 may be configured to send received queries to an embedding model which can vectorize the received query and store it in a vector database. In such embodiments, stored query embeddings may be used as a form of contextual data which may be retrieved and transmitted with the query to a GenAI model which generates a response based on the received query and contextual data.

According to the aspect, a response portal 720 is present and configured to receive a response from one a GenAI model and a response management system 730 determines if the received response needs to be curated or not. If the response does not need to be curated, then it may be sent as an uncrated response 702 to the user who submitted the query. Response management 730 can determine if there are any user/entity defined rules or preferences available such as stored in a user/entity profile in a data storage system of platform 120. Rules management 740 can retrieve said rules and response management can curate or otherwise augment the received response based on the user/entity rules or preferences. The result is a curated response 702 which can be transmitted back to the user who submitted the query.

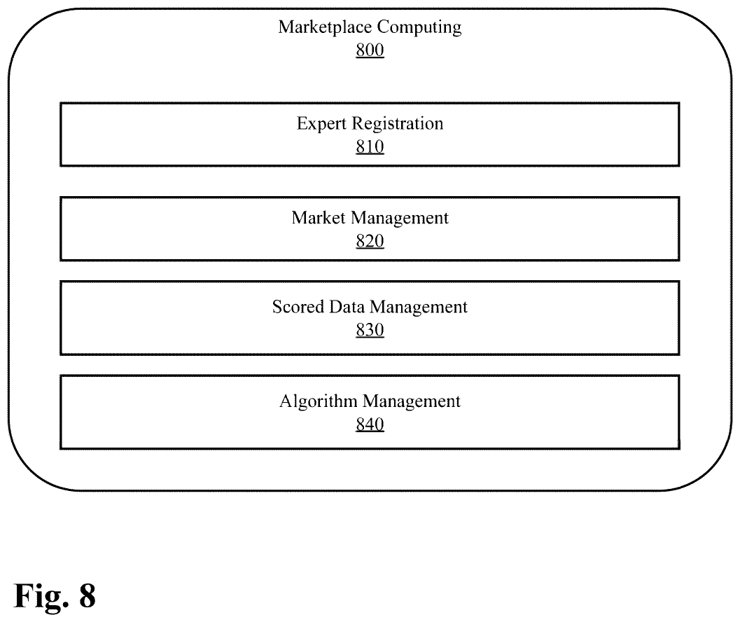

FIG. 8 is a block diagram illustrating an exemplary aspect of a distributed generative artificial intelligence reasoning and action platform, a marketplace computing system 800. According to the aspect, marketplace computing system 800 is present and configured to develop and integrate various marketplaces 130a-n for data, algorithms, and RAGs into platform 120. Marketplace computing system 800 can provide functionality directed to the registration of experts 810 or entities. An expert may be someone who has a deep understanding and knowledge of a specific industry, including its trends, challenges, technologies, regulations, and best practices. Industry experts often have many years of experience working in the industry and have developed a reputation for their expertise and insights. An expert may be registered by providing proof of identity and qualifications, and creating an expert profile which can store a variety of information about the expert such as their name, industry, credentials, scores (e.g., scores that the expert has assigned to data sources, models/algorithms, model outputs, and/or the like), and reputation. For example, a university professor who specializes in transformer-based algorithms can register as an expert in the realm of generative algorithms. As another example, a virologist could register as an expert and provide scores for academic papers which disclose a new methodology for viral spread modeling.

Marketplace computing system 800 may further comprise a market management component 820 which can interface with a plurality of markets 130a-n to integrate information contained therein. A scored data management component 830 may be configured to interface with a browser extension 240 or expert judgment marketplace 260 to retrieve expert scores and store them in an expert judgment score database 270. According to the aspect, an algorithm management component 840 is present and configured to acquire algorithms from algorithm marketplaces to be used in the construction and configuration of neuro-symbolic GenAI models.

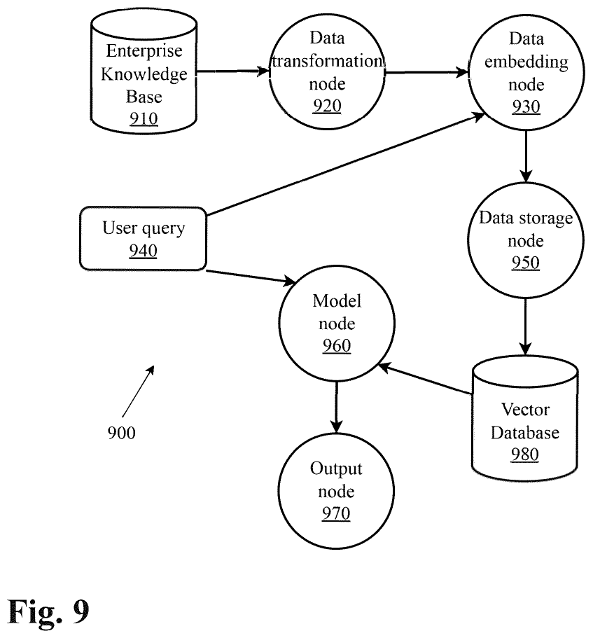

FIG. 9 is a block diagram illustrating a simple example of a distributed computational graph 900 representation for providing neuro-symbolic GenAI capabilities, according to an aspect. According to the aspect, the DCG may be represented as a series of nodes which represent discrete computational or data processing functions, and a series of edges connecting the nodes which represent information or data messages being sent between processing nodes. A DCG can be used to acquire a plurality of context data in the form of an enterprise knowledge base 910. A data transformation node 920 is created to handle the ingestion and transformation of acquired context data. Obtained data may then be sent to a data embedding node 930 which can vectorize the received context data. The vectorized data may flow from the embedding node 930 to a data storage node 950. Data storage node 950 may select the appropriate vector database 980 in which to store the vectorized context data. An input node 940 may allow for a user to submit a query to the workflow. The user query can be sent to data embedding node 930 where it may be vectorized and sent to data storage node 950 for storage in the vector database. The user query can also be sent to a model node 960 which contains the selected model(s) which will process the user query along with any relevant context data obtained from data storage node vector database 980. Model node 960 then processes this information to generate a response which can be sent to output node 970. In some instances, output node 970 may output the response directly to the user. In other instances, output node 970 may be configured to transform the response into a curated response based on user/entity defined rules or preferences.

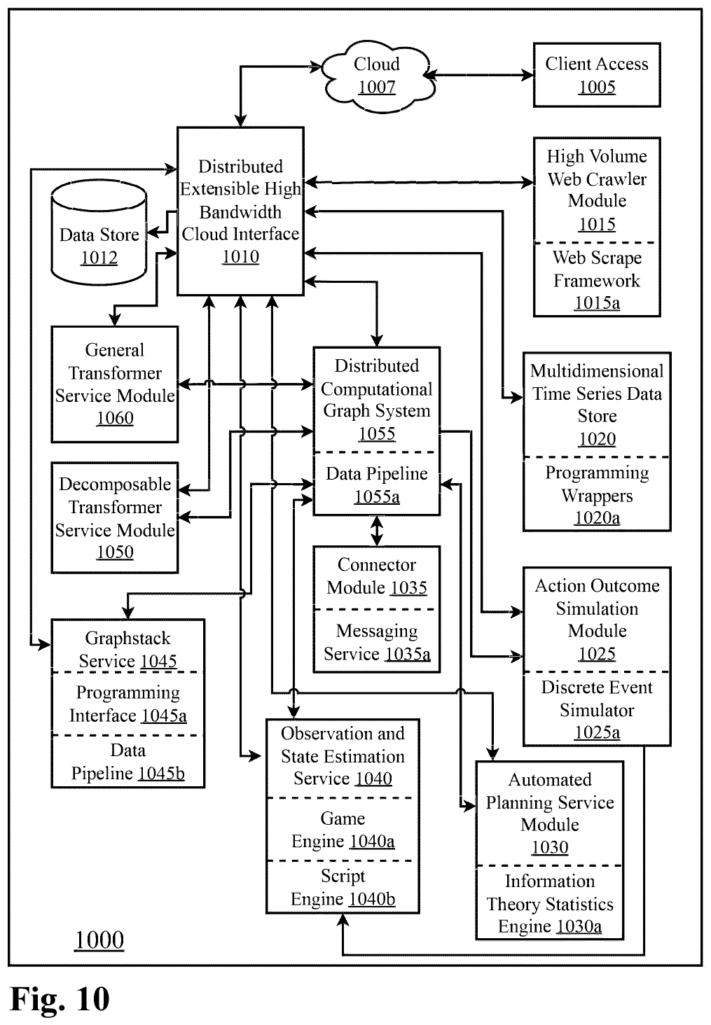

FIGS. 10-14 illustrate various exemplary aspects of system architectures of distributed computational graph computing environments. For more detailed information regarding the operation of the various components and aspects described herein with respect to FIGS. 10-14, please refer to U.S. patent application Ser. No. 15/931,534 which is incorporated herein by reference.

FIG. 10 is a block diagram illustrating an exemplary aspect of an embodiment of a distributed computational graph computing system utilizing an advanced cyber decision platform (ACDP) for external network reconnaissance and contextual data collection. Client access to the system 1005 for specific data entry, system control and for interaction with system output such as automated predictive decision making and planning and alternate pathway simulations, occurs through the system's distributed, extensible high bandwidth cloud interface 1010 which uses a versatile, robust web application driven interface for both input and display of client-facing information via network 1007 and operates a data store 1012 such as, but not limited to MONGODB™, COUCHDB™, CASSANDRA™ or REDIS™ according to various arrangements. Much of the enterprise knowledge/context data analyzed by the system both from sources within the confines of the enterprise business, and from cloud based sources, also enter the system through the cloud interface 1010, data being passed to the connector module 1035 which may possess the API routines 1035a needed to accept and convert the external data and then pass the normalized information to other analysis and transformation components of the system, the directed computational graph module 1055, high volume web crawler module 1015, multidimensional time series database (MDTSDB) 1020 and the graph stack service 1045. The directed computational graph module 1055 retrieves one or more streams of data from a plurality of sources, which includes, but is in no way not limited to, enterprise knowledge, RAGs, expert judgment/scores, a plurality of physical sensors, network service providers, web based questionnaires and surveys, monitoring of electronic infrastructure, crowdsourcing campaigns, and human input device information. Within the directed computational graph module 1055, data may be split into two identical streams in a specialized pre-programmed data pipeline 1055a, wherein one sub-stream may be sent for batch processing and storage while the other sub-stream may be reformatted for transformation pipeline analysis. The data is then transferred to the general transformer service module 1060 for linear data transformation as part of analysis or the decomposable transformer service module 1050 for branching or iterative transformations that are part of analysis. The directed computational graph module 1055 can represent all data as directed graphs where the transformations are nodes and the result messages between transformations edges of the graph. The high volume web crawling module 1015 uses multiple server hosted preprogrammed web spiders, which while autonomously configured are deployed within a web scraping framework 1015a of which SCRAPY™ and scripted headless browser variants are examples, to identify and retrieve data of interest from web based sources that are not well tagged by conventional web crawling technology. Data persistence stores such as the multiple dimension time series data store module 1020 may receive streaming data from a large plurality of sensors that may be of several different types. The multiple dimension time series data store module may also store any time series data encountered by the system such as but not limited to enterprise network usage data, component and system logs, environmental context, edge device state information, performance data, network service information captures such as, but not limited to news and financial feeds, and sales and service related customer data. The module is designed to accommodate irregular and high volume surges by dynamically allocating network bandwidth and server processing channels to process the incoming data. Inclusion of programming wrappers 1020a for languages examples of which are, but not limited to C++, PERL, PYTHON, Rust, GoLang, and ERLANG™ allows sophisticated programming logic to be added to the default function of the multidimensional time series database 1020 without intimate knowledge of the core programming, greatly extending breadth of function. Data retrieved by various data stores such as SQL, graph, key-value, or the multidimensional time series database (MDTSDB) 1020 and the high volume web crawling module 1015 may be further analyzed and transformed into task optimized results by the directed computational graph 1055 and associated general transformer service 1050 and decomposable transformer service 1060 modules. Alternately, data from the multidimensional time series database and high volume web crawling modules may be sent, often with scripted cuing information determining important vertexes 1045a, to the graph stack service module 1045 which, employing standardized protocols for converting streams of information into graph representations of that data, for example, open graph internet technology although the invention is not reliant on any one standard. Through the steps, the graph stack service module 1045 represents data in graphical form influenced by any predetermined scripted modifications 1045a and stores it in a graph-based data store 1045b such as GIRAPH™ or a key value pair type data store REDIS™, or RIAK™, among others, all of which are suitable for storing graph-based information.

Results of the transformative analysis process may then be combined with further client directives, and additional business rules and practices relevant to the analysis and situational information external to the already available data in the automated planning service module 1030 which also runs powerful information theory 1030a based predictive statistics functions and machine learning algorithms to allow future trends and outcomes to be rapidly forecast based upon the current system derived results and choosing each a plurality of possible business decisions. Using all available data, the automated planning service module 1030 may propose business decisions most likely to result is the most favorable business outcome with a usably high level of certainty. Closely related to the automated planning service module in the use of system derived results in conjunction with possible externally supplied additional information (i.e., context) in the assistance of end user business decision making, the action outcome simulation module 1025 with its discrete event simulator programming module 1025a coupled with the end user facing observation and state estimation service 1040 which is highly scriptable 1040b as circumstances require and has a game engine 1040a to more realistically stage possible outcomes of business decisions under consideration, allows business decision makers to investigate the probable outcomes of choosing one pending course of action over another based upon analysis of the current available data.

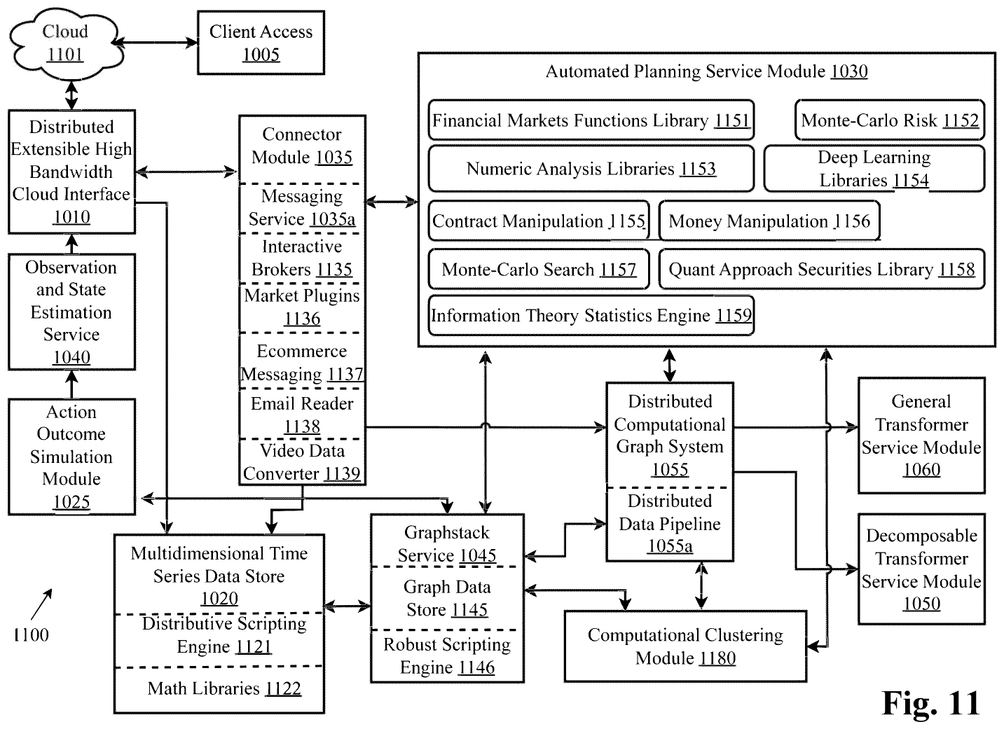

FIG. 11 is a block diagram illustrating another exemplary aspect of an embodiment 1100 of a distributed computational graph computing systems utilizing an advanced cyber decision platform. According to the aspect the integrated platform 1100, is very well suited to perform advanced predictive analytics and predictive simulations to produce investment predictions. Much of the trading specific programming functions are added to the automated planning service module 1030 of the modified advanced cyber decision platform 1100 to specialize it to perform trading analytics. Specialized purpose libraries may include but are not limited to financial markets functions libraries 1151, Monte-Carlo risk routines 1152, numeric analysis libraries 1153, deep learning libraries 1154, contract manipulation functions 1155, money handling functions 1156, Monte-Carlo search libraries 1157, and quant approach securities routines 1158. Pre-existing deep learning routines including information theory statistics engine 1159 may also be used. The invention may also make use of other libraries and capabilities that are known to those skilled in the art as instrumental in the regulated trade of items of worth. Data from a plurality of sources used in trade analysis are retrieved, much of it from remote, cloud resident 1101 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 1135, market data source plugins 1136, e-commerce messaging interpreters 1137, business-practice aware email reader 1138 and programming libraries to extract information from video data sources 1139.

Other modules that make up the advanced cyber decision platform may also perform significant analytical transformations on trade related data. These may include the multidimensional time series data store 1020 with its robust scripting features which may include a distributive friendly, fault-tolerant, real-time, continuous run prioritizing, programming platform such as, but not limited to Erlang/OTP 1121 and a compatible but comprehensive and proven library of math functions of which the C⁺⁺ math libraries are an example 1122, data formalization and ability to capture time series data including irregularly transmitted, burst data; the GraphStack service 145 which transforms data into graphical representations for relational analysis and may use packages for graph format data storage such as Titan 1145 or the like and a highly interface accessible programming interface an example of which may be Akka/Spray, although other, similar, combinations may equally serve the same purpose in this role 1146 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 1005 in formats best suited to convey both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 1025. Data and simulation formatting may be completed or performed by the observation and state estimation service 1040 using its ease of scripting and gaming engine to produce optimal presentation results.

In cases where there are both large amounts of data to be ingested, schematized, normalized, semantified or otherwise cleansed, enriched or formalized and then intricate transformations such as those that may be associated with deep machine learning, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 1180 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

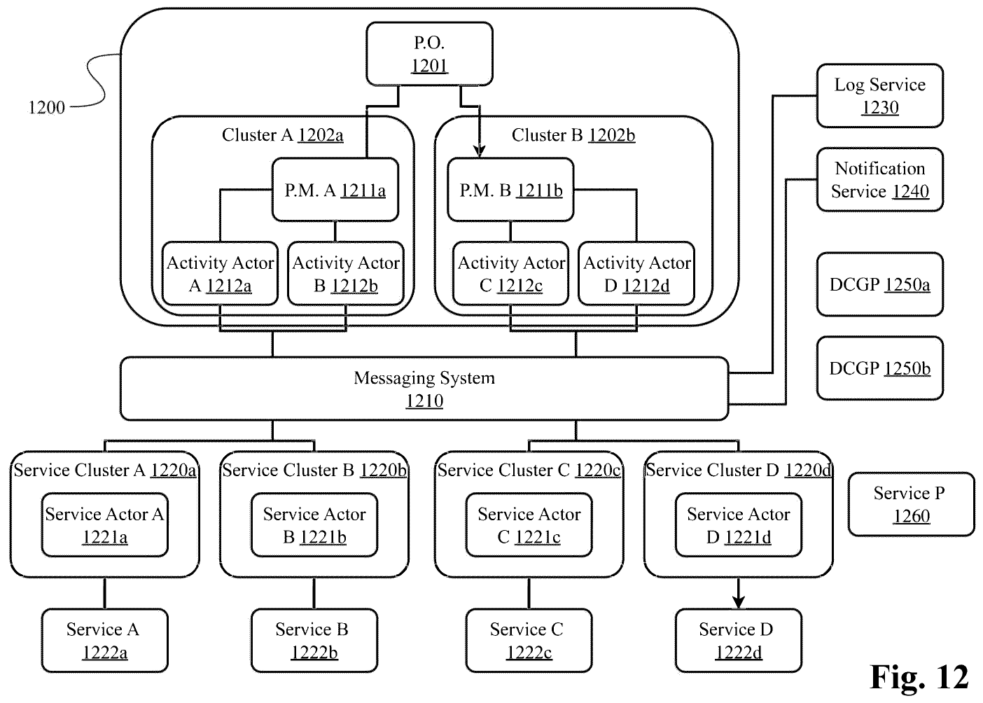

FIG. 12 is a diagram of an exemplary architecture for a system for rapid predictive analysis of very large data sets using an actor-driven distributed computational graph 1200, according to one aspect. According to the aspect, a DCG 1200 may comprise a pipeline orchestrator 1201 that may be used to perform a variety of data transformation functions on data within a processing pipeline, and may be used with a messaging system 1210 that enables communication with any number of various services and protocols, relaying messages and translating them as needed into protocol-specific API system calls for interoperability with external systems (rather than requiring a particular protocol or service to be integrated into a DCG 1200).

Pipeline orchestrator 1201 may spawn a plurality of child pipeline clusters 1202a-b, which may be used as dedicated workers for streamlining parallel processing. In some arrangements, an entire data processing pipeline may be passed to a child cluster 1202a for handling, rather than individual processing tasks, enabling each child cluster 1202a-b to handle an entire data pipeline in a dedicated fashion to maintain isolated processing of different pipelines using different cluster nodes 1202a-b. Pipeline orchestrator 1201 may provide a software API for starting, stopping, submitting, or saving pipelines. When a pipeline is started, pipeline orchestrator 1201 may send the pipeline information to an available worker node 1202a-b, for example using AKKA™ clustering. For each pipeline initialized by pipeline orchestrator 1201, a reporting object with status information may be maintained. Streaming activities may report the last time an event was processed, and the number of events processed. Batch activities may report status messages as they occur. Pipeline orchestrator 1201 may perform batch caching using, for example, an IGFS™ caching filesystem. This allows activities 1212a-d within a pipeline 1202a-b to pass data contexts to one another, with any necessary parameter configurations.

A pipeline manager 1211a-b may be spawned for every new running pipeline, and may be used to send activity, status, lifecycle, and event count information to the pipeline orchestrator 1201. Within a particular pipeline, a plurality of activity actors 1212a-d may be created by a pipeline manager 1211a-b to handle individual tasks, and provide output to data services 1222a-d. Data models used in a given pipeline may be determined by the specific pipeline and activities, as directed by a pipeline manager 1211a-b. Each pipeline manager 1211a-b controls and directs the operation of any activity actors 1212a-d spawned by it. A pipeline process may need to coordinate streaming data between tasks. For this, a pipeline manager 1211a-b may spawn service connectors to dynamically create TCP connections between activity instances 1212a-d. Data contexts may be maintained for each individual activity 1212a-d, and may be cached for provision to other activities 1212a-d as needed. A data context defines how an activity accesses information, and an activity 1212a-d may process data or simply forward it to a next step. Forwarding data between pipeline steps may route data through a streaming context or batch context.

A client service cluster 1230 may operate a plurality of service actors 1221a-d to serve the requests of activity actors 1212a-d, ideally maintaining enough service actors 1221a-d to support each activity per the service type. These may also be arranged within service clusters 1220a-d, in a manner similar to the logical organization of activity actors 1212a-d within clusters 1202a-b in a data pipeline. A logging service 1230 may be used to log and sample DCG requests and messages during operation while notification service 1240 may be used to receive alerts and other notifications during operation (for example to alert on errors, which may then be diagnosed by reviewing records from logging service 1230), and by being connected externally to messaging system 1210, logging and notification services can be added, removed, or modified during operation without impacting DCG 1200. A plurality of DCG protocols 1250a-b may be used to provide structured messaging between a DCG 1200 and messaging system 1210, or to enable messaging system 1210 to distribute DCG messages across service clusters 1220a-d as shown. A service protocol 1260 may be used to define service interactions so that a DCG 1200 may be modified without impacting service implementations. In this manner it can be appreciated that the overall structure of a system using an actor driven DCG 1200 operates in a modular fashion, enabling modification and substitution of various components without impacting other operations or requiring additional reconfiguration.

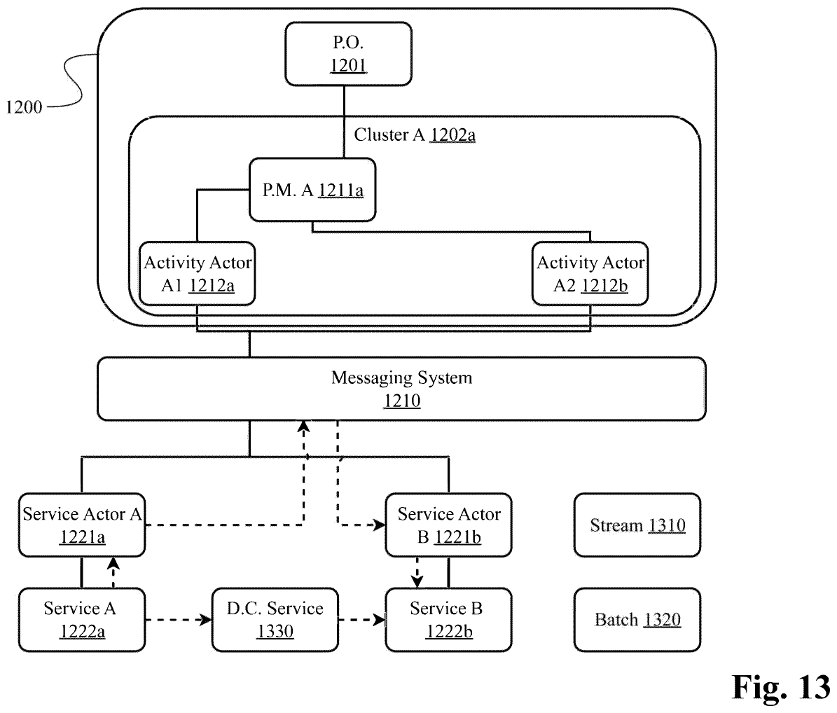

FIG. 13 is a diagram of an exemplary architecture for a system for rapid predictive analysis of very large data sets using an actor-driven distributed computational graph 1200, according to one aspect. According to the aspect, a variant messaging arrangement may utilize messaging system 1210 as a messaging broker using a streaming protocol 1310, transmitting and receiving messages immediately using messaging system 1210 as a message broker to bridge communication between service actors 1221a-b as needed. Alternately, individual services 1222a-b may communicate directly in a batch context 1320, using a data context service 1330 as a broker to batch-process and relay messages between services 1222a-b.

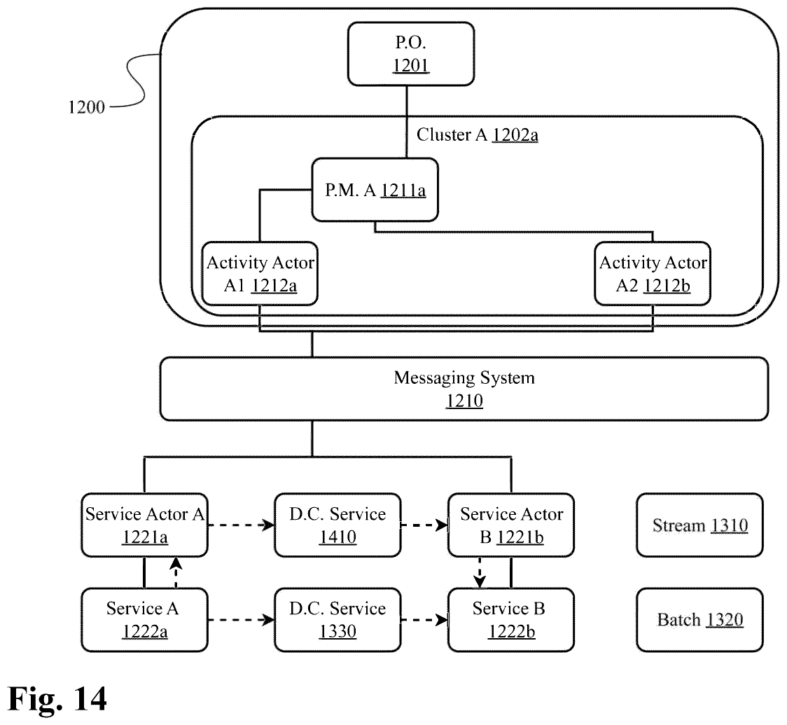

FIG. 14 is a diagram of an exemplary architecture for a system for rapid predictive analysis of very large data sets using an actor-driven distributed computational graph 1200, according to one aspect. According to the aspect, a variant messaging arrangement may utilize a service connector 1410 as a central message broker between a plurality of service actors 1221a-b, bridging messages in a streaming context 1310 while a data context service 1330 continues to provide direct peer-to-peer messaging between individual services 1222a-b in a batch context 1320.

It should be appreciated that various combinations and arrangements of the system variants described above (referring to FIGS. 10-14) may be possible, for example using one particular messaging arrangement for one data pipeline directed by a pipeline manager 1211a-b, while another pipeline may utilize a different messaging arrangement (or may not utilize messaging at all). In this manner, a single DCG 1200 and pipeline orchestrator 1201 may operate individual pipelines in the manner that is most suited to their particular needs, with dynamic arrangements being made possible through design modularity as described above in FIG. 12.

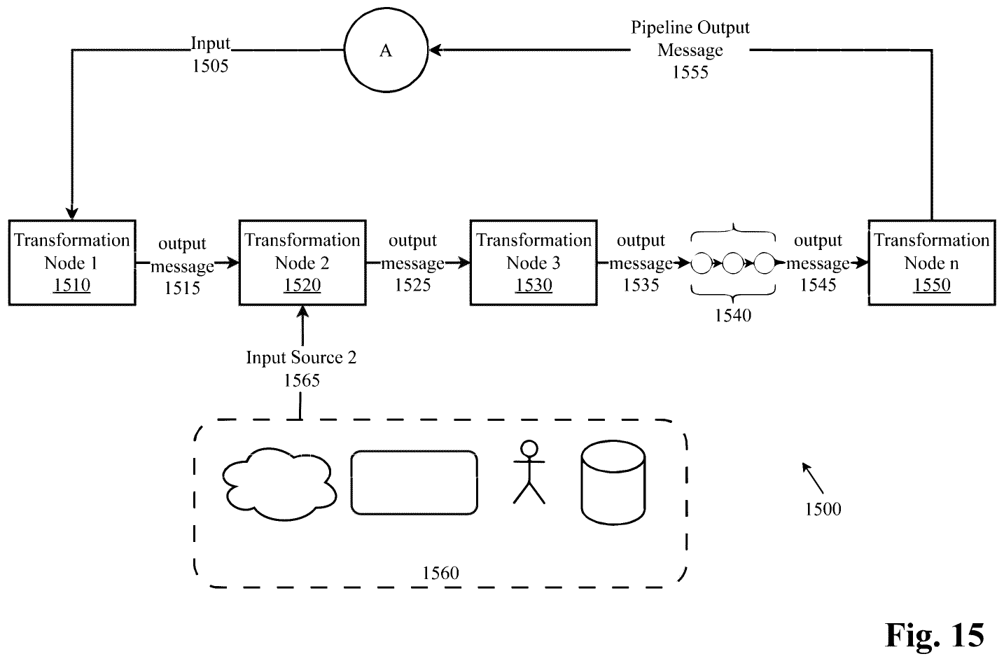

FIGS. 15-17 illustrate various exemplary aspects of system architectures and methods of distributed computational graph computing environments. For more detailed information regarding the operation of the various components and aspects described herein with respect to FIGS. 15-17, please refer to U.S. patent application Ser. No. 15/616,427 which is incorporated herein by reference.

FIG. 15 is a block diagram of an architecture for a transformation pipeline within a system for predictive analysis of very large data sets using distributed computational graph computing system 1500. According to the aspect, streaming input from a data filter software module, 1505 serves as input to the first transformation node 1510 of the transformation pipeline. Each transformation node's function 1510, 1520, 1530, 1540, 1550 is performed on input data stream and transformed output message 1515, 1525, 1535, 1545, 1555, 1565 is sent to the next step. In this aspect, transformation node 2 1520 has a second input stream 1560. The specific source of this input is inconsequential to the operation of the invention and could be another transformation pipeline software module, a data store, human interaction, physical sensors, monitoring equipment for other electronic systems or a stream from the internet as from a crowdsourcing campaign, just to name a few possibilities 1560. For example, a first input stream may comprise enterprise knowledge and a second input stream may comprise RAG data from a RAG marketplace. Functional integration of a second input stream into one transformation node requires the two input stream events be serialized. The illustrated system can perform this serialization using a decomposable transformation software module. While transformation nodes are described according to various aspects as uniform shape, such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. For example, engines may be singletons (composed of a single activity or transformation). Furthermore, leveraging the architecture in this way allows for versioning and functional decomposition (i.e. embedding entire saved workflows as single nodes in other workflows). Further according to the aspect, individual transformation nodes in one pipeline may represent function of another transformation pipeline. It should be appreciated that the node length of transformation pipelines depicted in no way confines the transformation pipelines employed by the invention to an arbitrary maximum length 1510, 1520, 1530, 1540, 1550, as, being distributed, the number of transformations would be limited by the resources made available to each implementation of the invention. It should be further appreciated that there need be no limits on transform pipeline length. Output of the last transformation node and by extension, the transform pipeline, 1550 may be sent back to messaging software module 562 for pre-decided action.

### Detailed Description of Exemplary Aspects

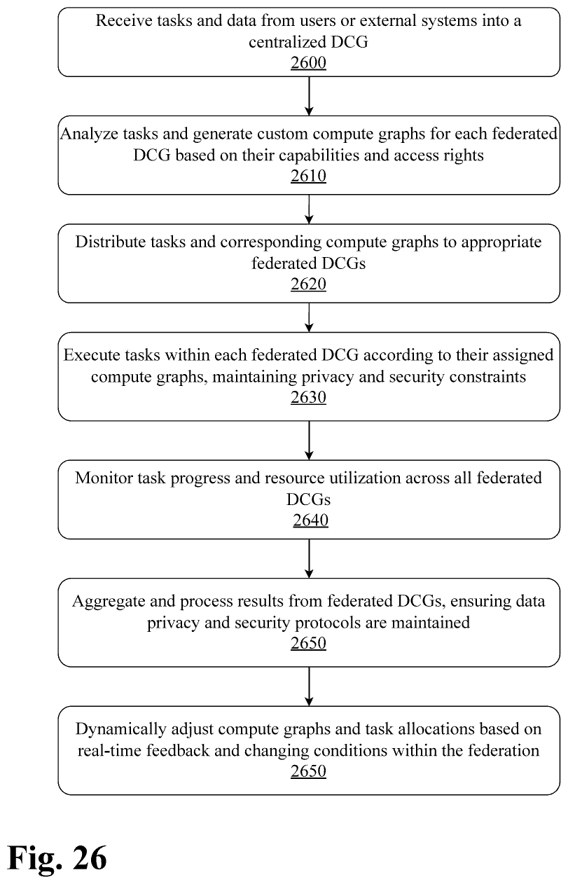

FIG. 26 is a flow diagram illustrating an exemplary method for a federated distributed graph-based computing platform. In a step 2600, the system receives tasks and data from users or external systems. This step initiates the federated computing process, where complex computational tasks are encoded into high-level computational graphs. These graphs represent the overall structure and dependencies of the required computations, and may include additional data such as application-specific information, machine learning models, datasets, or model weightings.

In a step 2610, the system analyzes the tasks and generates custom compute graphs for each federated node based on their capabilities and access rights. This involves examining each task to determine its specific requirements, such as computational power, data access needs, and security constraints. The system then creates tailored versions of the original computational graph, modified to fit the specific capabilities and access rights of each federated node. In a step 2620, the system distributes tasks and corresponding compute graphs to appropriate federated nodes. This involves securely transmitting these custom compute graphs to the respective federated nodes, along with any necessary data or models. This transmission occurs through a structured pipeline, ensuring efficient and secure distribution of tasks across the federation.

In a step 2630, tasks are executed within each federated node according to their assigned compute graphs, maintaining privacy and security constraints. The received compute graph is further broken down and distributed among internal components of each federated node. This step enables partial or blind execution, where some federated nodes may process only a portion of the overall computation, with limited visibility into the broader task. In a step 2640, the system monitors task progress and resource utilization across all federated nodes. As computations progress, each federated node reports back through the pipeline structure. This feedback includes task progress, resource utilization, and any issues encountered. The system aggregates this information, providing a high-level overview of the system's state.

In a step 2650, results from federated nodes are aggregated and processed, ensuring data privacy and security protocols are maintained. The system pieces together the final output from potentially encrypted or obfuscated results, maintaining the partial blindness of the execution where necessary. In a step 2660, the system dynamically adjusts compute graphs and task allocations based on real-time feedback and changing conditions within the federation. Based on the aggregated feedback, the system may decide to reallocate tasks or resources. It might modify compute graphs in real-time, reassign tasks to different federated nodes, or adjust resource allocations.

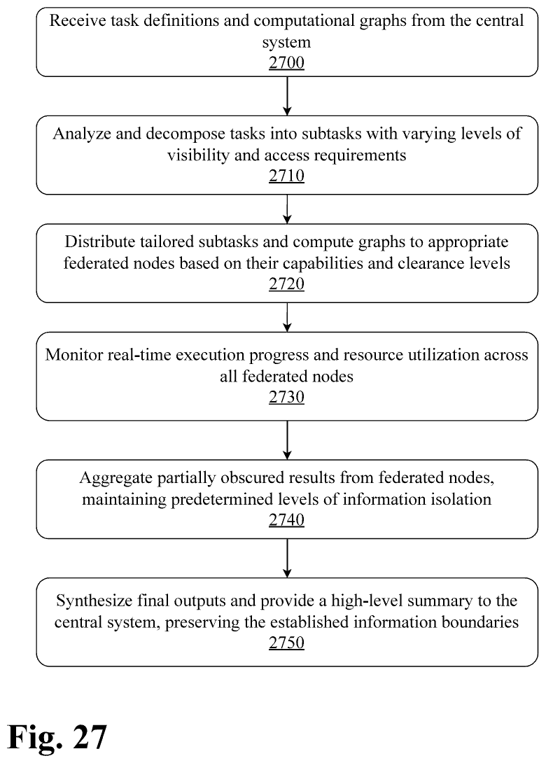

FIG. 27 is a flow diagram illustrating an exemplary method for a federated distributed graph-based computing platform that includes a federation manager. In a step 2700, the system receives task definitions and computational graphs from the central system. This initiates the process of distributed computing, where complex tasks are represented as computational graphs that can be broken down and distributed across the federation. These graphs encapsulate the structure, dependencies, and data requirements of the overall computational task.

In a step 2710, the system analyzes and decomposes tasks into subtasks with varying levels of visibility and access requirements. This step involves breaking down the received computational graphs into smaller, manageable components. Each subtask is assigned specific visibility and access levels, enabling the system to implement partial or blind execution strategies. This decomposition allows for fine-grained control over information flow within the federated network. In a step 2720, the system distributes tailored subtasks and compute graphs to appropriate federated nodes based on their capabilities and clearance levels. This distribution process takes into account the specific attributes of each federated node, including its computational resources, security clearance, and current workload. The system ensures that each node receives only the information and tasks it is authorized to process, maintaining the integrity of the partial blindness approach.

In a step 2730, the system monitors real-time execution progress and resource utilization across all federated nodes. This ongoing monitoring process allows the system to track the progress of distributed tasks, assess the performance of individual nodes, and identify any bottlenecks or issues in real-time. The system collects data on task completion rates, resource usage, and any anomalies encountered during execution. In a step 2740, the system aggregates partially obscured results from federated nodes, maintaining predetermined levels of information isolation. As federated nodes complete their assigned subtasks, they return results that may be intentionally obscured or encrypted to maintain the partial blindness of the execution. The system collects these results, ensuring that the predetermined levels of information isolation are preserved throughout the aggregation process.

In a step 2750, the system synthesizes final outputs and provides a high-level summary to the central system, preserving the established information boundaries. This final step involves combining the partially obscured results into a coherent output that addresses the original task requirements. The system generates a high-level summary that encapsulates the results of the distributed computation while carefully maintaining the information boundaries established earlier in the process. This summary is then provided to the central system, completing the federated computation cycle while preserving the security and privacy constraints of the distributed network.

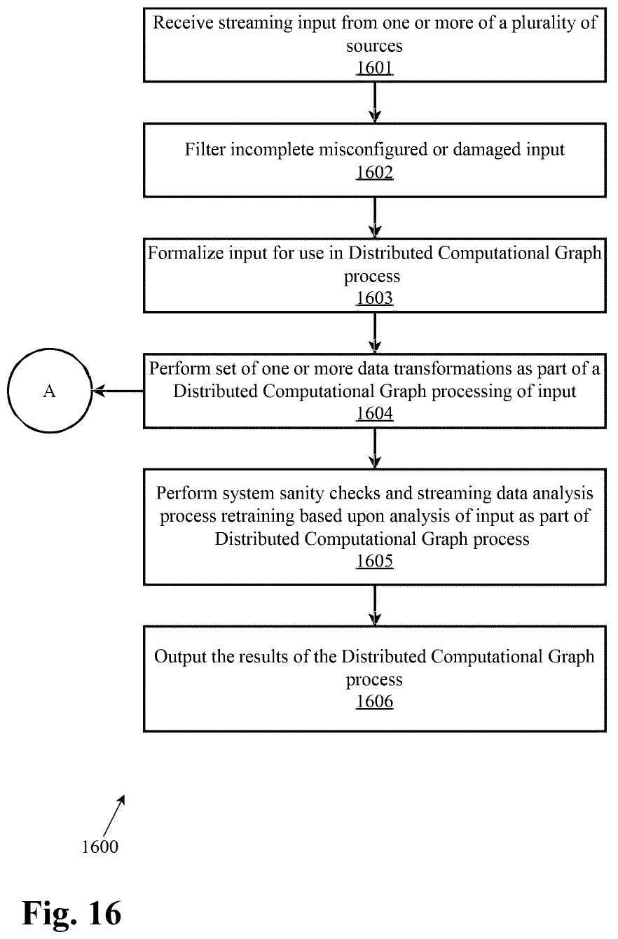

FIG. 16 is a process flow diagram of a method 1600 for predictive analysis of very large data sets using the distributed computational graph. One or more streams of data from a plurality of sources, which includes, but is in no way not limited to, a number of physical sensors, web-based questionnaires and surveys, monitoring of electronic infrastructure, crowd sourcing campaigns, and direct human interaction, may be received by system 1601. The received stream is filtered 1602 to exclude data that has been corrupted, data that is incomplete or misconfigured and therefore unusable, data that may be intact but nonsensical within the context of the analyses being run, as well as a plurality of predetermined analysis related and unrelated criteria set by the authors. Filtered data may be split into two identical streams at this point (second stream not depicted for simplicity), wherein one substream may be sent for batch processing 1600 while another substream may be formalized 1603 for transformation pipeline analysis 1604, 1500, and retraining 1605. Data formalization for transformation pipeline analysis acts to reformat the stream data for optimal, reliable use during analysis. Reformatting might entail, but is not limited to: setting data field order, standardizing measurement units if choices are given, splitting complex information into multiple simpler fields, and stripping unwanted characters, again, just to name a few simple examples. The formalized data stream may be subjected to one or more transformations. Each transformation acts as a function on the data and may or may not change the data. Within the invention, transformations working on the same data stream where the output of one transformation acts as the input to the next are represented as transformation pipelines. While the great majority of transformations in transformation pipelines receive a single stream of input, modify the data within the stream in some way and then pass the modified data as output to the next transformation in the pipeline, the invention does not require these characteristics. According to the aspect, individual transformations can receive input of expected form from more than one source or receive no input at all as would a transformation acting as a timestamp. According to the aspect, individual transformations, may not modify the data as would be encountered with a data store acting as a queue for downstream transformations. According to the aspect, individual transformations may provide output to more than one downstream transformations. This ability lends itself to simulations where multiple possible choices might be made at a single step of a procedure all of which need to be analyzed. While only a single, simple use case has been offered for each example, in each case, that example was chosen for simplicity of description from a plurality of possibilities, the examples given should not be considered to limit the invention to only simplistic applications. Last, according to the invention, transformations in a transformation pipeline backbone may form a linear, a quasi-linear arrangement or may be cyclical, where the output of one of the internal transformations serves as the input of one of its antecedents allowing recursive analysis to be run. The result of transformation pipeline analysis may then be modified by results from batch analysis of the data stream and output 1606 in format predesigned by the authors of the analysis with could be human readable summary printout, human readable instruction printout, human-readable raw printout, data store, or machine encoded information of any format known to the art to be used in further automated analysis or action schema.

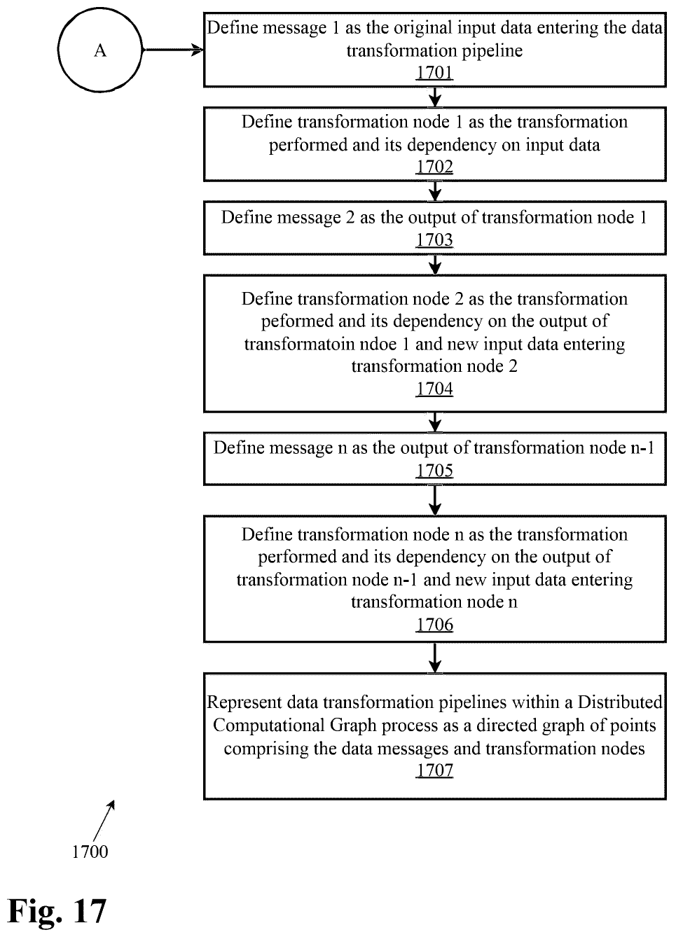

FIG. 17 is a process flow diagram of a method 1700 for an aspect of modeling the transformation pipeline module as a directed graph using graph theory. According to the aspect, the individual transformations 17102, 17104, 17106 of the transformation pipeline t₁ . . . tₙ such that each tᵢ T are represented as graph nodes. Transformations belonging to T are discrete transformations over individual datasets dᵢ, consistent with classical functions. As such, each individual transformation tⱼ, receives a set of inputs and produces a single output. The input of an individual transformation tᵢ is defined with the function in: tᵢ d₁ . . . dₖ such that in(tᵢ)={d₁ . . . dₖ) and describes a transformation with k inputs. Similarly, the output of an individual transformation is defined as the function out: tᵢ [ld₁] to describe transformations that produce a single output (usable by other transformations). A dependency function can now be defined such that dep(tₐ,t_{b}) out(tₐ)in(t_{b}) The messages carrying the data stream through the transformation pipeline 1701,1703, 1705 make up the graph edges. Using the above definitions, then, a transformation pipeline within the invention can be defined as G=(V,E) where message (t₁, t₂ . . . t(ₙ₋₁), tₙ)V and all transformations t₁ . . . tₙ and all dependencies dep(tᵢ,tⱼ)E 1707.

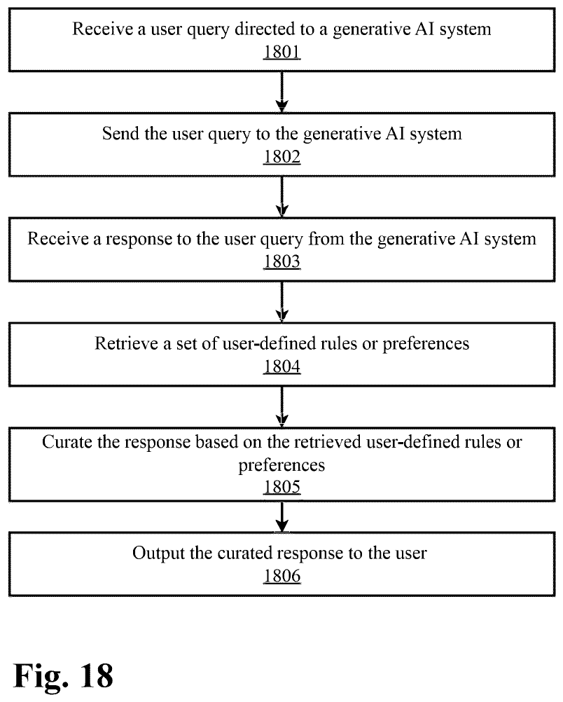

FIG. 18 is a flow diagram illustrating an exemplary method for providing experience curation, according to an aspect of an embodiment. According to the aspect, the process begins at step 1801 when a distributed generative AI reasoning and action platform receives a user query directed to a generative AI system. The query may comprise a request for information, a summary, a request for a document, or some other action. The user may submit their query to the platform via an experience curation portal such as through a webapp or website accessed via an Internet browser operating on a computer (e.g., personal computer, laptop), or through an associated curation application which can be operated on a mobile computing device (e.g., smart phone, tablet, smart wearable, IoT device, etc.). In some implementations, the received user query may be sent to a data embedding system which can vectorize the query and store it in a vector database where it may be retrieved to be used as contextual data included in a query/prompt sent to a generative AI system.

At step 1802 the query is sent to the generative AI system which processes the query and returns a generated response which is received by the platform at step 1803. At step 1804 curation system locates and retrieves any available user-defined rules or preferences. In some embodiments, the user-defined rules/preferences may be defined by an entity (e.g., a company). Exemplary rules or preferences can include, but are not limited to, conditional generation preferences, formatting rules, language rules, style rules, geographic rules, environmental rules, and timing rules. With respect to conditional generation rules, the model can be conditioned on specific input data related to the individual, such as preferences, behavior, and characteristics. For example, in text generation, the model could be conditioned on a user's previous messages or writing style to generate more personalized responses. Formatting, style, and language rules are closely related and may be used to curate a response in a specific format (e.g., bullet points, paragraph, single sentence, numbered outline, CSV, etc.), response style (e.g., formal, informal, academic, accessible, abstract, casual, etc.), and the language in which a response is translated, respectively. At step 1805 curation system can curate the response based on the retrieved user-defined rules or preferences. For example, the system may filter out extraneous data, or personal information. As a last step 1806, curation system returns the curated response to the user, thereby providing experience curation to a platform user.

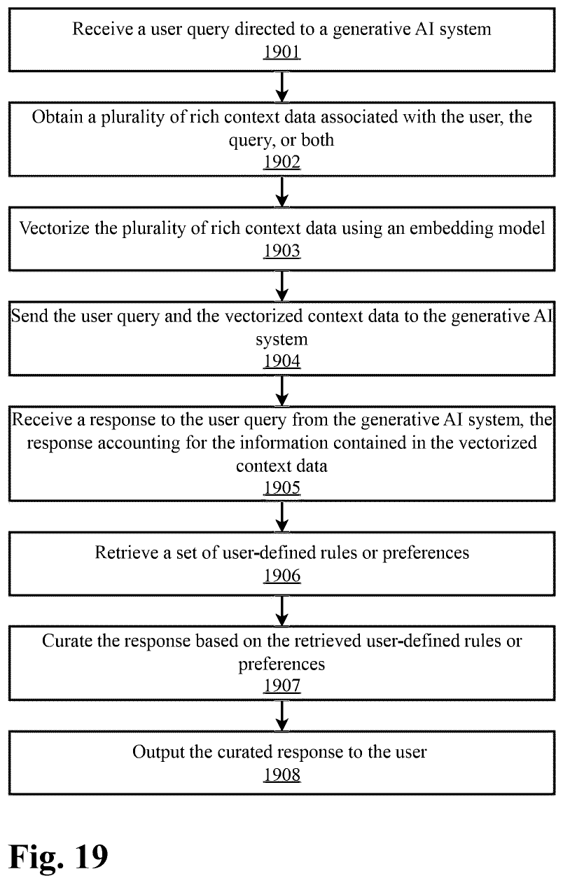

FIG. 19 is a flow diagram illustrating an exemplary method for providing experience curation with using rich contextual data, according to an aspect of an embodiment. According to the aspect, the process begins at step 1901 when a distributed generative AI reasoning and action platform receives a user query directed to a generative AI system. The query may comprise a request for information, a summary, a request for a document, or some other action. The user may submit their query to the platform via an experience curation portal such as through a webapp or website accessed via an Internet browser operating on a computer (e.g., personal computer, laptop), or through an associated curation application which can be operated on a mobile computing device (e.g., smart phone, tablet, smart wearable, IoT device, etc.). In some implementations, the received user query may be sent to a data embedding system which can vectorize the query and store it in a vector database where it may be retrieved to be used as contextual data included in a query/prompt sent to an ML, AI, generative AI, planning, or automation/action orchestration system.

A DCG orchestrated model which employs a hierarchical classification and model selection regime for content (either in whole or in part) can enable much more accurate ultimate semantic performance. For example, a query/prompt can be submitted to the generative AI system with additional metadata associated with the context of the prompt itself as well as additional broader information about the user and the user's ongoing behavior and/or activities. At step 1902 the system obtains a plurality of rich context data associated with the user, the query, or both. A subset of the plurality of context data information may be obtained from a vector database, the vector database comprising a plurality of embedded contextual data. Embedded contextual data can comprise (but is not limited to) information obtained from an enterprise knowledge base and embedded queries/prompts. Context data associated with the user may comprise information obtained from or related to one or more of a computing device on which the user is accessing the curation system/platform, the geographic location the user is located, an action the user is performing during interaction with the curation system/platform, and timing data associated with the user, and/or the like. A subset of the plurality of obtained context data may be obtained from one or more marketplaces such as a data marketplace and/or an expert judgment marketplace. In some embodiments, the selection of context data may be based on one or more expert judgment scores assigned to an information source or dataset.

As an example, if a user is asking a generative AI enhanced search engine for “the best pizza” on her cell phone while driving at 55 mph on the road and not near her home (e.g. on vacation) this is massively different from the user being at home, on her couch, connected on her laptop, from her normal IP address, having just ran a series of searches for airline tickets to Italy and Neapolitan Pizza recipes. The additional device, user, recent behavior, etc. content can be used by a classifier alongside a prompt to help focus results on things that are not only relevant (e.g. pizza places near the user that are open now) but likely to be consistent with her broader needs/persona (e.g. if available, the suggestions could be looked at based on other budget, dining, etc. preferences like outdoor seating and meals below $20 per person). The same principle applies to more complicated and complex topics like medicine or finance or law.

At step 1903 the obtained plurality of context data may be processed into vectors by an embedding model and stored in the vector database.

At step 1904 the user query and the vectorized context data is sent to the generative AI system which processes the query and returns a generated response which accounts for the information contained in the vectorized context data and which is received by the platform at step 1905. At step 1906 curation system locates and retrieves any available user-defined rules or preferences. In some embodiments, the user-defined rules/preferences may be defined by an entity (e.g., a company). Exemplary rules or preferences can include, but are not limited to, conditional generation preferences, formatting rules, language rules, style rules, geographic rules, environmental rules, and timing rules. With respect to conditional generation rules, the model can be conditioned on specific input data related to the individual, such as preferences, behavior, and characteristics. For example, in text generation, the model could be conditioned on a user's previous messages or writing style to generate more personalized responses. Formatting, style, and language rules are closely related and may be used to curate a response in a specific format (e.g., bullet points, paragraph, single sentence, numbered outline, CSV, etc.), response style (e.g., formal, informal, academic, accessible, abstract, casual, etc.), and the language in which a response is translated, respectively. At step 1907 curation system can curate the response based on the retrieved user-defined rules or preferences. For example, the system may filter out extraneous data, or personal information. As a last step 1908, curation system returns the curated response to the user, thereby providing experience curation to a platform user.

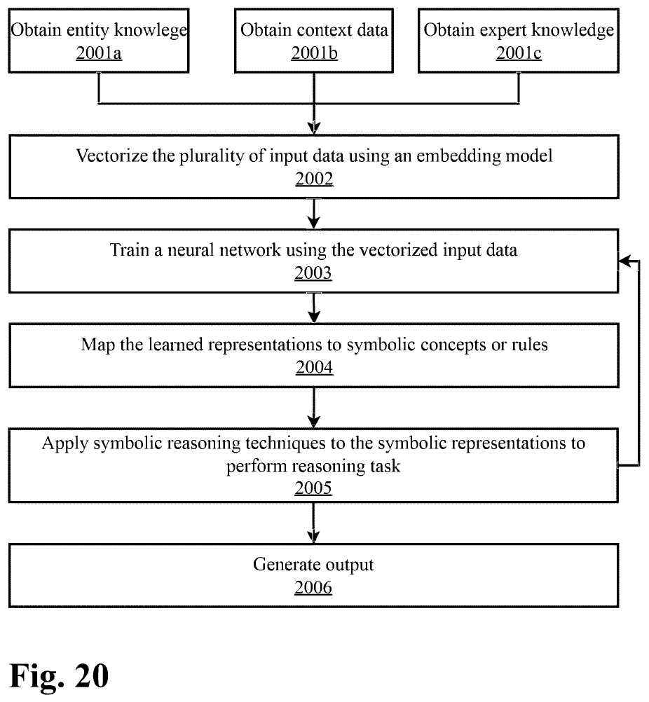

FIG. 20 is a flow diagram illustrating an exemplary method for providing distributed neuro-symbolic reasoning and action model, according to an aspect of an embodiment. A neuro-symbolic model combines neural network-based approaches with symbolic reasoning to enable a more flexible and powerful reasoning system. In neuro-symbolic reasoning, neural networks are used to learn representations of data, similar to how they are used in deep learning. These learned representations can then be combined with symbolic representations and rules to perform reasoning tasks. This combination allows for the strengths of both approaches to be leveraged: the ability of neural networks to learn complex patterns from data, and the ability of symbolic reasoning to represent and manipulate abstract concepts and rules.

According to the aspect, the process begins at step 2001a-c wherein a plurality of input data is obtained from various sources. Examples of input data can include entity knowledge 2001a, context data 2001b, and expert knowledge 2001c. Other types of data may be obtained and may be dependent upon the embodiment and the particular use case. Data may be obtained from third-party services, entity databases/data warehouses/knowledge base and/or the like, and various marketplaces for data, algorithms, RAGs, and/or expert judgment. At step 2002 the obtained plurality of input data is vectorized using an embedding model and stored in a vector database. Vectorizing the data allows it to be used as input for processing by a neural network. At step 2003 platform 120 can train the neural network using the input data to learn patterns and relationships in the data. In some embodiments, this step may involve the use of labeled examples and supervised learning. A recurrent neural network or some other transformer-based model may be used as the basis for the neural network. At step 2004 the system maps the learned representations to symbolic concepts or rules. At this step, the system learns to represent the learned features or representations from the neural network in symbolic form. At step 2005 the system applies reasoning techniques to the symbolic representations to perform reasoning tasks. Examples of reasoning techniques that may be implemented can include, but are not limited to, logic rules or inference engines. This step may involve combining the learned representations with existing knowledge or rules to derive new conclusions. At this point in the process a feedback loop is created wherein feedback from the symbolic reasoning step is incorporated back into the neural network to refine the learned representations. This feedback loop helps to improve the performance of the system over time. As a last step 2006, the trained, distributed GenAI reasoning and action model can generate output of the reasoning process, which could be a decision, a prediction, or an action based on the input data and the reasoning process. In some embodiment, the input data may further include a query/prompt and metadata comprising various contextual information about the user and/or prompt.

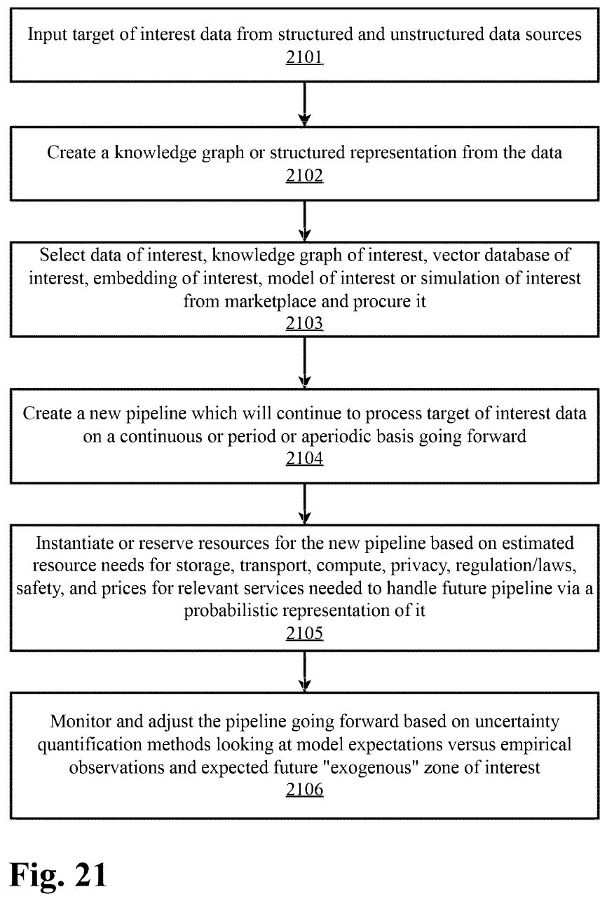

FIG. 21 is a flow diagram illustrating an exemplary method for using a distributed computation graph system for creating structured representations or knowledge graphs from various data sources, and setting up a pipeline for continuous processing and monitoring of that data, according to an embodiment. According to the embodiment, the process begins at step 2101 when the platform receives a plurality of input data of interest from structured (e.g., databases, spreadsheets, etc.) and unstructured (e.g., documents, websites, social media, etc.) data sources. Data may be obtained using data extraction techniques such as, for example, web scraping, APIs, natural language processing, etc.). Additionally, or alternatively, the data may be obtained from a data marketplace (e.g., expert judgment, RAGs, models, datasets, etc.). At step 2102 platform creates a knowledge graph or structured representation from data of interest. This may comprise applying information extraction methods (e.g., named entity recognition, relation extraction, etc.) to extract entities and relationships from unstructured data and integrating the extracted information with structured data sources. Further, a knowledge graph representation can be built by creating nodes for entities and edges for relationships. Optionally, platform can be configured to create vector representations of entities/relationships using techniques like word embeddings.

At step 2103, platform selects data of interest, knowledge graph of interest, vector database of interest, embedding of interest, model of interest or simulation of interest from marketplace and procures it. Platform can search/browse a marketplace or repository for relevant data sources, knowledge graphs, vector databases, models, simulations, etc., and evaluate the potential options based on factors like relevance, quality, and cost. This step may further include purchasing or licensing selected assets for use in a pipeline. As a next step 2104, platform creates a new pipeline which will continue to process target of interest data on a continuous or periodic or aperiodic basis going forward. The pipeline may be designed (e.g., batch, streaming, etc.) based on the processing needs and can integrate components for data ingestion, knowledge graph updates, model execution and/or the like.

At step 2105, platform can instantiate or reserve resources for the new pipeline based on estimated resource needs for storage, transport, compute, privacy, regulation/laws, safety, and prices for relevant services needed to handle future pipeline via a probabilistic representation of it. Platform may estimate pipeline resource requirements (storage, compute, networking, etc.) and also consider privacy, regulatory, and safety constraints that impact resource needs. Platform may use probabilistic modeling to forecast future resource demands. This step may further comprise provisioning cloud/on-premise resources (e.g., virtual machines, containers, databases, etc.) accordingly. As a last step 2106, platform monitors and adjusts the pipeline going forward based on uncertainty quantification methods looking at model expectations versus empirical observations and expected future “exogenous” zone of interest. A pipeline may be monitored for performance, data drift, model accuracy, etc. and by tracking metrics like data volumes, processing times, error rates, and model accuracies. Platform may use techniques such as, for example, Bayesian modeling to quantify uncertainties in model parameters and propagate input/parameter uncertainties through the model(s) to get prediction uncertainties. Techniques such as bootstrap, cross-validation can also quantify model uncertainties. Platform can identify external variables (e.g., new regulations, market shifts, technology changes, etc.) that may impact the “zone of interest” and quantify potential impacts on pipeline performance/relevance. As an example, platform could implement monitoring for these variables using web scraping, news feeds, etc.

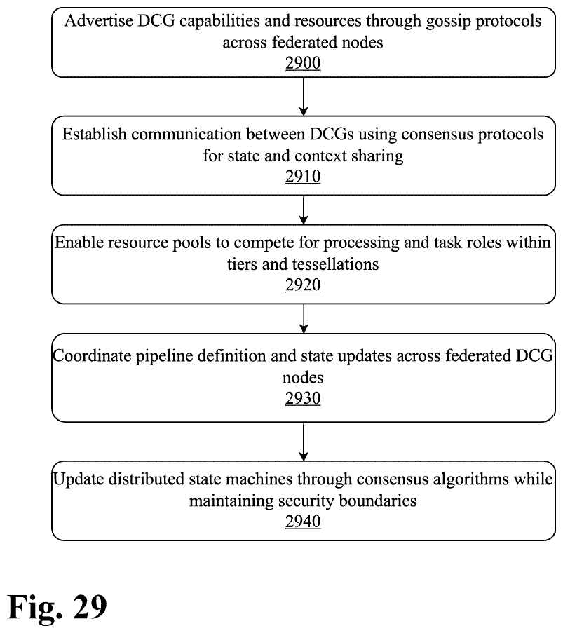

FIG. 29 is a flow diagram illustrating an exemplary method for implementing gossip and consensus flows within and across tiers/tessellations of resource pools in a federated distributed graph-based computing platform. In step 2900, each DCG advertises its capabilities and available resources to peers through gossip protocols. This enables DCGs to operate in a fully decentralized manner, with workloads distributed through direct DCG-to-DCG communication without requiring central coordination.

At step 2910, the system establishes communication between DCGs using industry-standard consensus protocols. This may include but is not limited to the Zookeeper Atomic Broadcast (ZAB) protocol, the Raft consensus algorithm and associated communication model in KRaft, or other protocols and consensus algorithms like Paxos, or serverless implementations like FaasKeeper. These protocols enable distributed state and job objective management through DCG intercommunication. This flexibility in protocol selection and implementation is critical for enabling more advanced kinds of federated and transfer learning at scale and better addressing privacy concerns, data locality regulations/restrictions, and user preferences on top of efficiency in processing, transport and storage of data at massive scale.

At step 2920, the system enables resource pools to compete for processing and task roles within tiers and tessellations. DCGs within a federation communicate context and state as needed to accomplish job objectives. This enables potential tiers or tessellations of resource pools to compete for both processing and task roles, while also supporting pipeline definition and state updates. This competition and coordination can occur in a fully decentralized manner, where DCGs discover and coordinate with each other through gossip protocols, enabling workloads to be distributed through direct DCG-to-DCG communication without requiring central coordination.

At step 2930, the system coordinates pipeline definition and state updates across federated DCG nodes. This implements the federation capabilities, where DCGs coordinate pipeline definition and context and state updates across the federation. The system supports execution of data flows and orchestration of resources across cloud (e.g., hyperscale), self-managed (e.g., traditional data center) computer clusters, CDNs (e.g., forward content distribution networks that may expand from historical distribution of web content into forward hosting of data sets, models, AI tools, etc. . . . ), edge devices, wearables and mobile devices, and individual computers. This enables computational graph specifications to be communicated between different people, processes, AI agents and collections of logical or hardware resources.

In step 2940, the system updates distributed state machines through consensus algorithms while maintaining security boundaries. This enables sharing and availability of information across systems via distributed state machine and associated gossip methods and consensus protocols. The system aggregates contextual data from local or global and internal or external sources or other localized DCG processes in the federated system made known to it, whether within a given system or as shared or made available from other systems. This approach supports continuous learning from both empirical observations and hypothetical state space explorations of decision spaces, particularly applicable to decision making under uncertainty in complex adaptive systems but also with applicability for everyday interactions and delegated agentic activities.

According to an aspect, the process enables multi-stakeholder distributed artificial intelligence reasoning and action through a cloud-based computing architecture. The system maintains flexibility through distributed state and job objective management, critical for enabling advanced kinds of federated and transfer learning at scale while addressing privacy concerns, data locality regulations/restrictions, and user preferences. This is facilitated by ongoing analysis of the system of interest to the observer, including awareness of observer perspective, which is typically (but not necessarily) the beneficiary of the flow-based computing enabled by the system. The system supports both empirical observations and hypothetical state space explorations of decision spaces, making it particularly applicable to decision making under uncertainty in complex adaptive systems while also supporting everyday interactions and delegated agentic activities across multiple scales, geographies, and timeframes.

### Exemplary Computing Environment

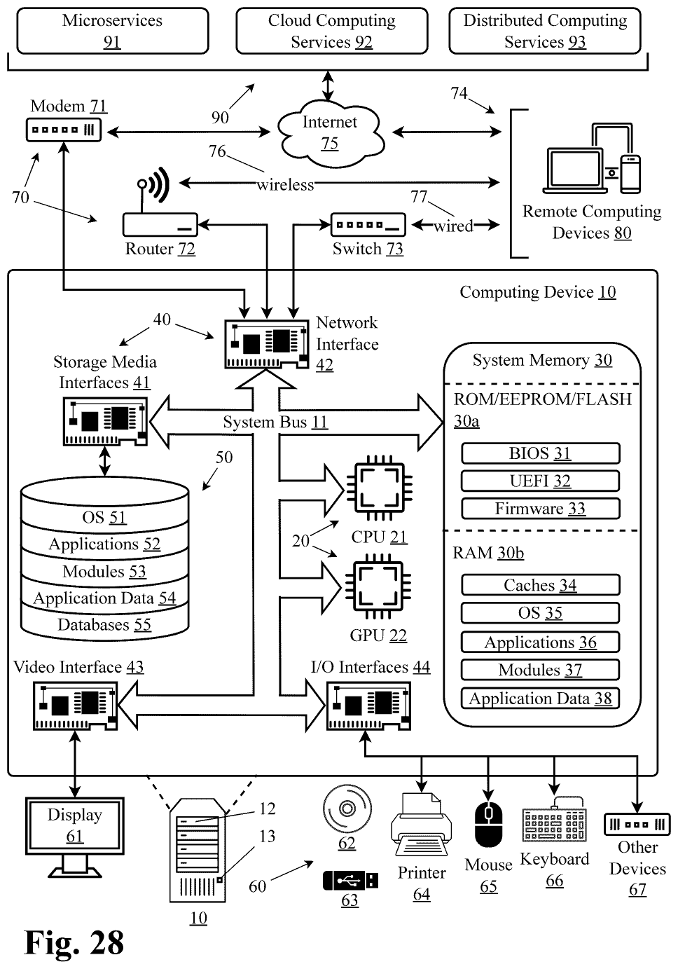

FIG. 28 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for a federated distributed graph-based computing platform with an integrated hardware management layer, the computing system comprising:
one or more hardware processors configured for:
receiving a plurality of tasks from a first plurality of federated distributed graph-based systems;
forwarding the plurality of tasks to a centralized distributed graph-based system;
analyzing and decomposing tasks into a plurality of subtasks with varying levels of visibility and access requirements;
generating a plurality of compute graphs that represent the plurality of subtasks;
distributing the plurality of compute graphs to a second plurality of federated distributed graph-based systems which comprises a plurality of privacy and security settings; and
executing the subtasks represented by the plurality of compute graphs.

2. The computing system of claim 1, wherein the second plurality of federated distributed graph-based systems are assigned subtasks from the plurality of subtasks based on the second plurality of federated distributed graph-based systems' privacy and security settings.

3. The computing system of claim 2, wherein the plurality of compute graphs contain various amounts of information, such that some of the second plurality of federated distributed graph-based systems are provided with more information than others.

4. The computing system of claim 1, wherein the plurality of tasks, subtasks, and compute graphs are received, forwarded, analyzed, and distributed through a data pipeline network that connects the first plurality of federated graph-based systems, the centralized distributed graph-based system, and the second plurality of federated distributed graph-based systems.

5. A computer-implemented method executed on a federated distributed graph-based computing platform, the computer-implemented method comprising:
receiving a plurality of tasks from a first plurality of federated distributed graph-based systems;
forwarding the plurality of tasks to a centralized distributed graph-based system;
analyzing and decomposing tasks into a plurality of subtasks with varying levels of visibility and access requirements;
generating a plurality of compute graphs that represent the plurality of subtasks;
distributing the plurality of compute graphs to a second plurality of federated distributed graph-based systems which comprises a plurality of privacy and security settings; and
executing the subtasks represented by the plurality of compute graphs.

6. The computer-implemented method of claim 5, wherein the second plurality of federated distributed graph-based systems are assigned subtasks from the plurality of subtasks based on the second plurality of federated distributed graph-based systems' privacy and security settings.

7. The computer implemented method of claim 6, wherein the plurality of compute graphs contain various amounts of information, such that some of the second plurality of federated distributed graph-based systems are provided with more information than others.

8. The computer-implemented method of claim 5, wherein the plurality of tasks, subtasks, and compute graphs are received, forwarded, analyzed, and distributed through a data pipeline network that connects the first plurality of federated graph-based systems, the centralized distributed graph-based system, and the second plurality of federated distributed graph-based systems.

9. A system for a federated distributed graph-based computing platform with an integrated hardware management layer, comprising one or more computers with executable instructions that, when executed, cause the system to:
receive a plurality of tasks from a first plurality of federated distributed graph-based systems;
forward the plurality of tasks to a centralized distributed graph-based system;
analyze and decomposing tasks into a plurality of subtasks with varying levels of visibility and access requirements;
generate a plurality of compute graphs that represent the plurality of subtasks;
distribute the plurality of compute graphs to a second plurality of federated distributed graph-based systems which comprises a plurality of privacy and security settings; and
execute the subtasks represented by the plurality of compute graphs.

10. The system of claim 9, wherein the second plurality of federated distributed graph-based systems are assigned subtasks from the plurality of subtasks based on the second plurality of federated distributed graph-based systems' privacy and security settings.

11. The system of claim 10, wherein the plurality of compute graphs contain various amounts of information, such that some of the second plurality of federated distributed graph-based systems are provided with more information than others.

12. The system of claim 9, wherein the plurality of tasks, subtasks, and compute graphs are received, forwarded, analyzed, and distributed through a data pipeline network that connects the first plurality of federated graph-based systems, the centralized distributed graph-based system, and the second plurality of federated distributed graph-based systems.
